(19) United States
(12) Patent Application Publication
(10) Pub. No.: US 2025/0038810 A1
(43) Pub. Date: Jan. 30, 2025

(54) CSI FOR JOINT TRANSMISSION WITH ADAPTATION HYPOTHESES

(71) Applicant: Samsung Electronics Co., Ltd., Suwon-si (KR)

(72) Inventors: Jeongho Jeon, San Jose, CA (US); Aristides Papasakellariou, Houston, TX (US)

(21) Appl. No.: 18/769,281

(22) Filed: Jul. 10, 2024

Related U.S. Application Data
(60) Provisional application No. 63/528,841, filed on Jul. 25, 2023.
(60) Provisional application No. 63/531,134, filed on Aug. 7, 2023.

(51) Int. Cl. H04B 7/06; H04W 72/1273

(52) U.S. Cl. CPC H04B 7/0626; H04W 72/1273

(57) ABSTRACT

Apparatuses and methods for channel state information (CSI) for joint transmission with adaptation hypotheses. A method for a user equipment (UE) to report channel state information (CSI) includes receiving: information related to a CSI reference signal (CSI-RS) resource set including one or more non-zero power CSI-RSs (NZP CSI-RSs) on a cell, information related to a CSI report including a first number of CSI report sub-configurations, information related to an uplink (UL) channel for transmitting the CSI report, and the one or more NZP CSI-RSs. The method further includes determining a second number of CSI sub-reports based on the reception of the one or more NZP CSI-RSs and transmitting the UL channel with the CSI report including the second number of CSI sub-reports based on the fourth information.

### CROSS-REFERENCE TO RELATED AND CLAIM OF PRIORITY

The present application claims priority under 35 U.S.C. § 119 (e) to U.S. Provisional Patent Application No. 63/528,841 filed on Jul. 25, 2023, and U.S. Provisional Patent Application No. 63/531,134 filed on Aug. 7, 2023, which are hereby incorporated by reference in their entirety.

### TECHNICAL FIELD

The present disclosure relates generally to wireless communication systems and, more specifically, the present disclosure is related to apparatuses and methods for channel state information (CSI) for joint transmission with adaptation hypotheses.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to CSI for joint transmission with adaptation hypotheses.

In one embodiment, a method for a user equipment (UE) to report channel state information (CSI) is provided. The method includes receiving: first information related to a CSI reference signal (CSI-RS) resource set including one or more non-zero power CSI-RSs (NZP CSI-RSs) on a cell, second information related to a CSI report including a first number of CSI report sub-configurations, third information related to an uplink (UL) channel for transmitting the CSI report, and the one or more NZP CSI-RSs based on the first information. A CSI report sub-configuration provides information related to a reception of one or more NZP CSI-RSs associated with a set of active transmission reception points (TRPs). A CSI report sub-configuration corresponds to a CSI sub-report for the set of active TRPs. The method further includes determining a second number of CSI sub-reports based on the second information, the fourth information, and the reception of the one or more NZP CSI-RSs associated with the set of active TRPs of the corresponding CSI report sub-configuration and transmitting the UL channel with the CSI report including the second number of CSI sub-reports based on the fourth information.

In another embodiment, a UE is provided. The UE includes a transceiver configured to receive: first information related to a CSI-RS resource set including one or more NZP CSI-RSs on a cell, second information related to a CSI report including a first number of CSI report sub-configurations, third information related to an UL channel for transmitting the CSI report, and the one or more NZP CSI-RSs based on the first information. A CSI report sub-configuration provides information related to a reception of one or more NZP CSI-RSs associated with a set of active TRPs. A CSI report sub-configuration corresponds to a CSI sub-report for the set of active TRPs. The UE further includes a processor operably coupled to the transceiver. The processor is configured to determine a second number of CSI sub-reports based on the second information, and the reception of the one or more NZP CSI-RSs associated with the set of active TRPs of the corresponding CSI report sub-configuration. The transceiver is further configured to transmit the UL channel with the CSI report including the second number of CSI sub-reports based on the fourth information.

In yet another embodiment, a base station (BS) is provided. The BS includes a transceiver configured to transmit: first information related to a CSI-RS resource set including one or more NZP CSI-RSs on a cell, second information related to a CSI report including a first number of CSI report sub-configurations, third information related to an uplink (UL) channel for the CSI report, and the one or more NZP CSI-RSs. A CSI report sub-configuration provides information related to a transmission of one or more NZP CSI-RSs associated with a set of active TRPs. A CSI report sub-configuration corresponds to a CSI sub-report for the set of active TRPs. The transceiver is further configured to receive the UL channel with the CSI report including a second number of CSI sub-reports based on the fourth information, wherein the second number of CSI sub-reports is based on the second information, and the transmission of the one or more NZP CSI-RSs associated with the set of active TRPs of the corresponding CSI report sub-configuration.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIGS. 6A and 6B illustrate an example of a transmitter and receiver structures using orthogonal frequency division multiplexing (OFDM) according to embodiments of the present disclosure;

FIGS. 7A and 7B illustrate a flow diagram of an encoding and decoding processes for downlink control information (DCI) according to embodiments of the present disclosure;

FIG. 8 illustrates an example system of a cooperative multiple transmission reception point (mTRP) according to embodiments of the present disclosure;

FIGS. 9A and 9B illustrate timelines for example cell discontinued transmissions (DTX) and discontinued receptions (DRX) according to embodiments of the present disclosure;

FIG. 10 illustrates diagrams of example spatial domain (SD) adaptations according to embodiments of the present disclosure;

FIG. 11 illustrates diagrams of example mTRP on/off adaptations according to embodiments of the present disclosure;

FIG. 12 illustrates a diagram of an example channel state information reference signal (CSI-RS) antenna port mapping with mTRP on/off adaptation according to embodiments of the present disclosure;

FIG. 13 illustrates a flowchart of an example UE procedure for reporting CSI for coherent joint transmission (CJT) from mTRP with on/off adaptations according to embodiments of the present disclosure;

FIG. 14 illustrates a diagram of associations for CSI-RS resources with CSI report sub-configurations according to embodiments of the present disclosure;

FIG. 15 illustrates a diagram of example CSI-RS antenna port mapping with mTRP on/off adaptation and Type-1 SD adaptation according to embodiments of the present disclosure;

FIG. 16 illustrates a flowchart of an example UE procedure for reporting CSI for CJT from mTRP(s) with Type-1 SD adaptations according to embodiments of the present disclosure;

FIG. 17 illustrates a diagram of example associations for CSI-RS resources with CSI report sub-configurations according to embodiments of the present disclosure;

FIG. 18 illustrates a diagram of example CSI-RS antenna port mapping with mTRP on/off adaptation and Type-2 SD adaptation according to embodiments of the present disclosure;

FIG. 19 illustrates a flowchart of an example UE procedure for reporting CSI for CJT from mTRP(s) with Type-2 SD adaptations according to embodiments of the present disclosure;

FIG. 20 illustrates a diagram of example associations for CSI-RS resources with CSI report sub-configurations according to embodiments of the present disclosure;

FIG. 21 illustrates an example system of a cooperative mTRP according to embodiments of the present disclosure;

FIG. 22 illustrates an example system of CSI-RS resource configuration for non-coherent joint transmission (NC-JT) according to embodiments of the present disclosure;

FIG. 23 illustrates a flowchart of an example UE procedure for reporting CSI for NC-JT from mTRPs with on/off adaptations according to embodiments of the present disclosure;

FIG. 24 illustrates a flowchart of an example UE procedure for reporting CSI for NC-JT from mTRPs with Type-1 SD adaptations according to embodiments of the present disclosure;

FIG. 25 illustrates a diagram of example associations for CSI-RS resources with CSI report sub-configurations according to embodiments of the present disclosure;

FIG. 26 illustrates a diagram of example Type-1 SD adaptation configurations of CSI-RS antenna ports from a TRP according to embodiments of the present disclosure;

FIG. 27 illustrates a flowchart of an example UE procedure for reporting CSI for NC-JT from mTRPs with Type-2 SD adaptations according to embodiments of the present disclosure; and

FIG. 28 illustrates a diagram of associations for CSI-RS resources with CSI report sub-configurations according to embodiments of the present disclosure.

### DETAILED DESCRIPTION

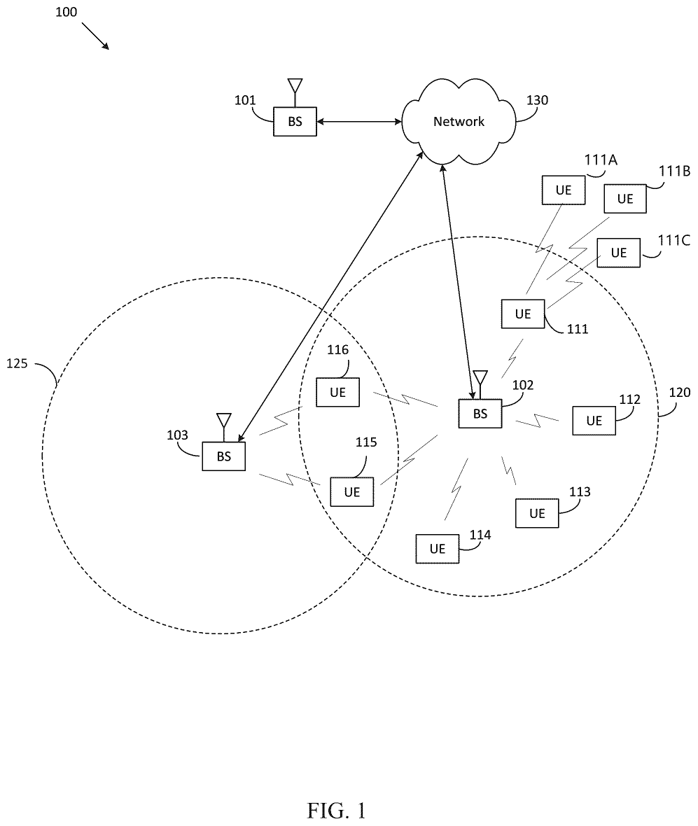

FIGS. 1-28, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v17.4.0, “NR; Physical channels and modulation;” [2] 3GPP TS 38.212 v17.4.0, “NR; Multiplexing and channel coding;” [3] 3GPP TS 38.213 v17.4.0, “NR; Physical layer procedures for control;” [4] 3GPP TS 38.214 v17.4.0, “NR; Physical layer procedures for data;” [5] 3GPP TS 38.215 v17.4.0, “NR; Physical layer measurements;” and [6] 3GPP TS 38.321 v17.3.0, “NR; Medium Access Control (MAC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally regarded as a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for determining CSI for joint transmission with adaptation hypotheses. In certain embodiments, one or more of the BSs 101-103 include circuitry, programing, or a combination thereof to support determination of CSI for joint transmission with adaptation hypotheses.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

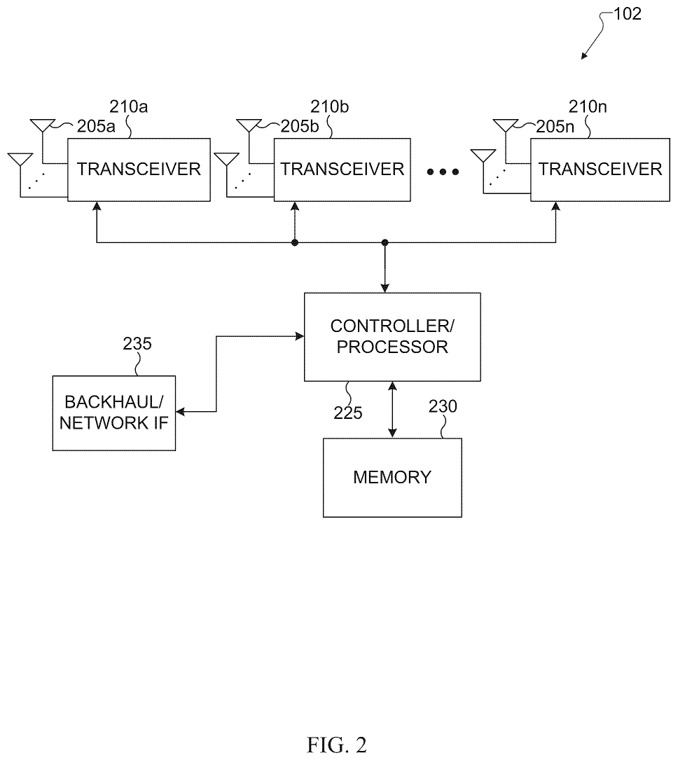

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for determining CSI for joint transmission with adaptation hypotheses. Any of a wide variety of other functions could be supported in the gNB 102 by the controller/processor 225.

The controller/processor 225 is also capable of executing programs and other processes resident in the memory 230, such as processes for supporting CSI for joint transmission with adaptation hypotheses. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

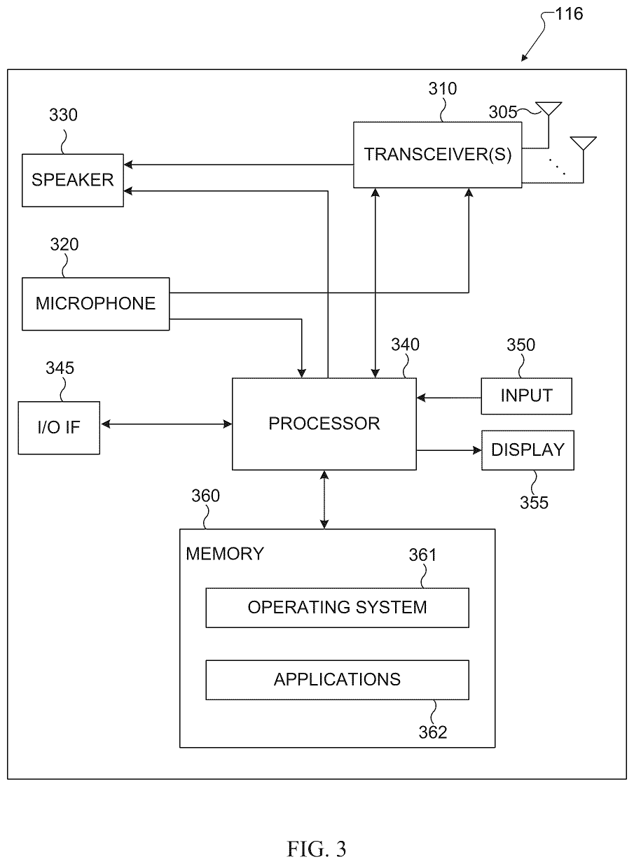

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for determining CSI for joint transmission with adaptation hypotheses as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

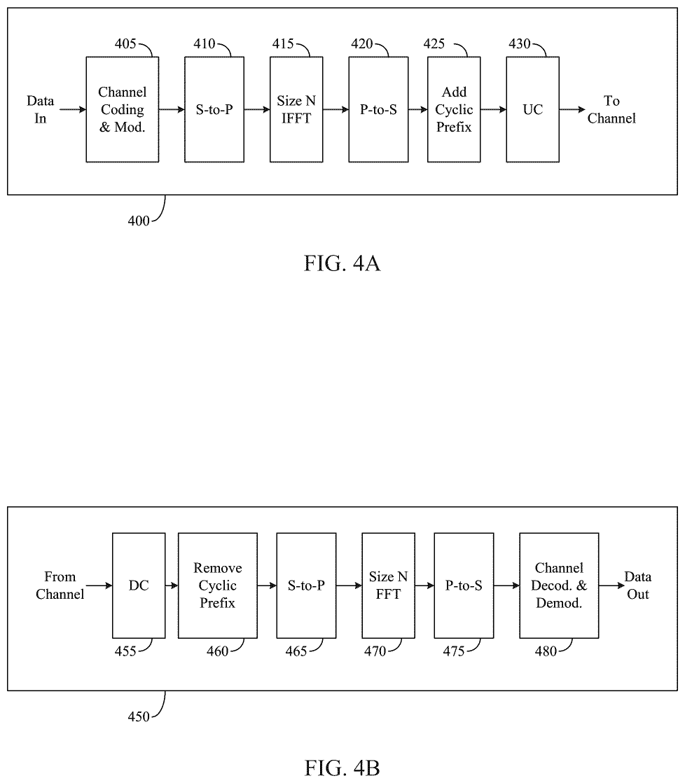

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for transmission of CSI for joint transmission with adaptation hypotheses as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In embodiments of the present disclosure, a beam is determined by either a transmission configuration indicator (TCI) state that establishes a quasi-colocation (QCL) relationship between a source reference signal (RS) (e.g., single sideband (SSB) and/or Channel State Information Reference Signal (CSI-RS)) and a target RS or a spatial relation information that establishes an association to a source RS, such as SSB or CSI-RS or sounding RS (SRS). In either case, the ID of the source reference signal identifies the beam. The TCI state and/or the spatial relation reference RS can determine a spatial RX filter for reception of downlink channels at the UE 116, or a spatial TX filter for transmission of uplink channels from the UE 116.

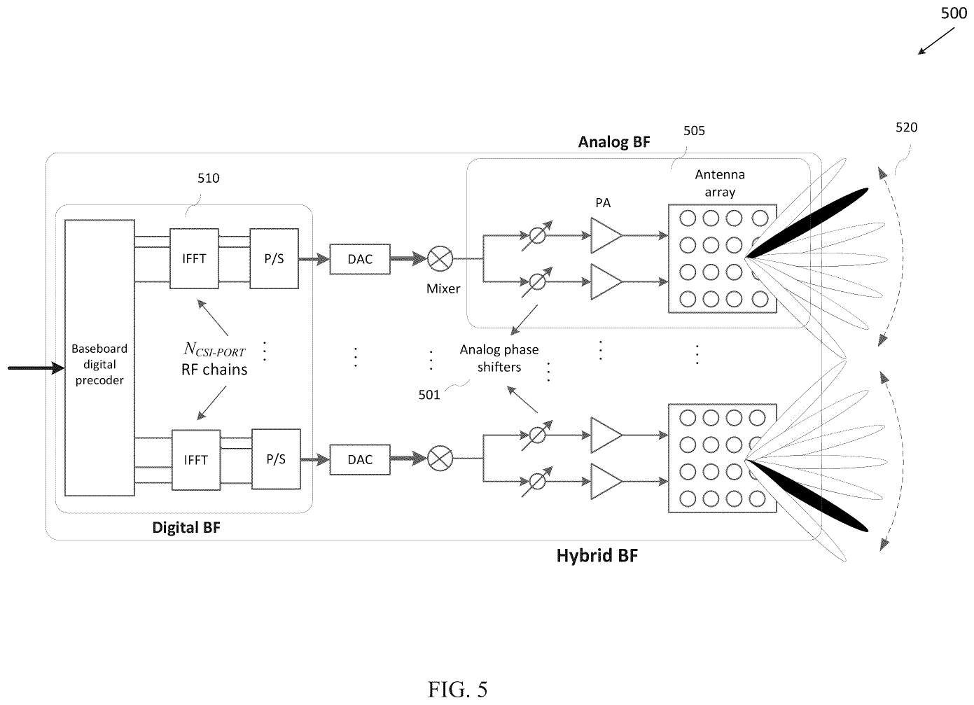

FIG. 5 illustrates an example of a transmitter structure 500 for beamforming according to embodiments of the present disclosure. In certain embodiments, one or more of gNB 102 or UE 116 includes the transmitter structure 500. For example, one or more of antennas 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NGSI-PORT. A digital beamforming unit 510 performs a linear combination across NCSI-PORT analog beams to further increase a precoding gain. While analog beams are wideband (hence not frequency-selective), digital precoding can be varied across frequency subbands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 500 for beamforming is for illustration only and other embodiments can be used without departing from the scope of the present disclosure.

In the following, an italicized name for a parameter implies that the parameter is provided by higher layers.

DL transmissions or UL transmissions can be based on an OFDM waveform including a variant using DFT precoding that is known as DFT-spread-OFDM that is typically applicable to UL transmissions.

In the following, subframe (SF) refers to a transmission time unit for the LTE RAT and slot refers to a transmission time unit for an NR RAT. For example, the slot duration can be a sub-multiple of the SF duration. NR can use a different DL or UL slot structure than an LTE SF structure. Differences can include a structure for transmitting physical downlink control channels (PDCCHs), locations and structure of demodulation reference signals (DM-RS), transmission duration, and so on. Further, eNB refers to a base station serving UEs operating with LTE RAT and gNB refers to a base station serving UEs operating with NR RAT. Exemplary embodiments evaluate a same numerology, which includes a sub-carrier spacing (SCS) configuration and a cyclic prefix (CP) length for an OFDM symbol, for transmission with LTE RAT and with NR RAT. In such case, OFDM symbols for the LTE RAT as same as for the NR RAT, a subframe is same as a slot and, for brevity, the term slot is subsequently used in the remaining of the disclosure.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}·15 kHz. A unit of one sub-carrier over one symbol is referred to as resource element (RE). A unit of one RB over one symbol is referred to as physical RB (PRB).

DL signaling include physical downlink shared channels (PDSCHs) conveying information content, PDCCHs conveying DL control information (DCI), and reference signals (RS). A PDCCH can be transmitted over a variable number of slot symbols including one slot symbol and over a number of control channel elements (CCEs) from a predetermined set of numbers of CCEs referred to as CCE aggregation level within a control resource set (CORESET) as described in 3GPP TS 36.211 v17.4.0, “NR; Physical channels and modulation”, and 3GPP TS 38.213 v17.4.0 “NR; Physical Layer procedures for control”.

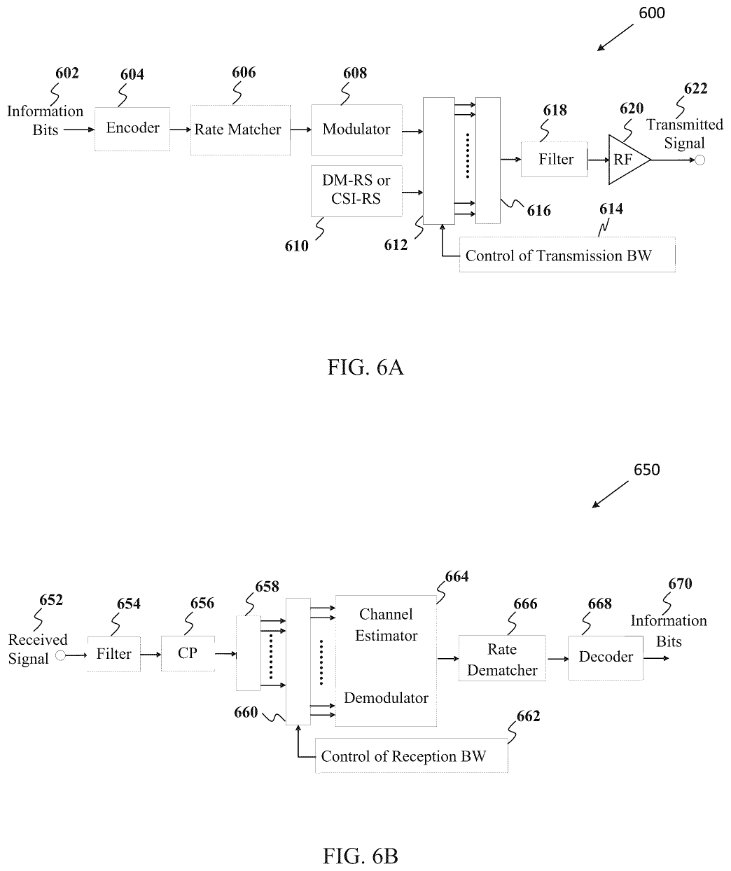

FIGS. 6A and 6B illustrate an example of transmitter and receiver structures 600 and 650, respectively, using OFDM according to embodiments of the present disclosure. For example, a transmit structure 600 may be described as being implemented in a gNB (such as gNB 102), while a receive structure 650 may be described as being implemented in a UE (such as UE 116). This example is for illustration only and other embodiments can be used without departing from the scope of the present disclosure.

Information bits, such as DCI bits or data bits 602, are encoded by encoder 604, rate matched to assigned time/frequency resources by rate matcher 606 and modulated by modulator 608. Subsequently, modulated encoded symbols and DM-RS or CSI-RS 610 are mapped to REs 612 by RE mapping unit 614, an inverse fast Fourier transform (IFFT) is performed by filter 616, a cyclic prefix (CP) is added by CP insertion unit 618, and a resulting signal is filtered by filter 620 and transmitted by a radio frequency (RF) unit 622.

A received signal 652 is filtered by filter 654, a CP removal unit removes a CP 656, a filter 658 applies a fast Fourier transform (FFT), RE de-mapping unit 660 de-maps REs selected by BW selector unit 662, received symbols are demodulated by a channel estimator and a demodulator unit 664, a rate de-matcher 666 restores a rate matching, and a decoder 668 decodes the resulting bits to provide information bits 670.

DCI can serve several purposes. A DCI format includes a number of fields, or information elements (IEs), and is typically used for scheduling a PDSCH (DL DCI format) or a physical uplink shared channel (PUSCH) (UL DCI format) transmission. A DCI format includes cyclic redundancy check (CRC) bits in order for a UE to confirm a correct detection. A DCI format type is identified by a radio network temporary identifier (RNTI) that scrambles the CRC bits. For a DCI format scheduling a PDSCH or a PUSCH for a single UE with radio resource control (RRC) connection to a gNB, the RNTI is a cell RNTI (C-RNTI) or another RNTI type such as a modulation and coding scheme (MCS)-C-RNTI. For a DCI format scheduling a PDSCH conveying system information (SI) to a group of UEs, the RNTI is a SI-RNTI. For a DCI format scheduling a PDSCH providing a response to a random access (RA) from a group of UEs, the RNTI is a RA-RNTI. For a DCI format scheduling a PDSCH providing contention resolution in Msg4 of a RA process, the RNTI is a temporary C-RNTI (TC-RNTI). For a DCI format scheduling a PDSCH paging a group of UEs, the RNTI is a paging RNTI (P-RNTI). For a DCI format providing transmission power control (TPC) commands to a group of UEs, the RNTI is a Transmit Power Control (TPC)-RNTI, and so on. Each RNTI type is configured to a UE through higher layer signaling. A UE typically decodes at multiple candidate locations for potential PDCCH receptions as determined by an associated search space set.

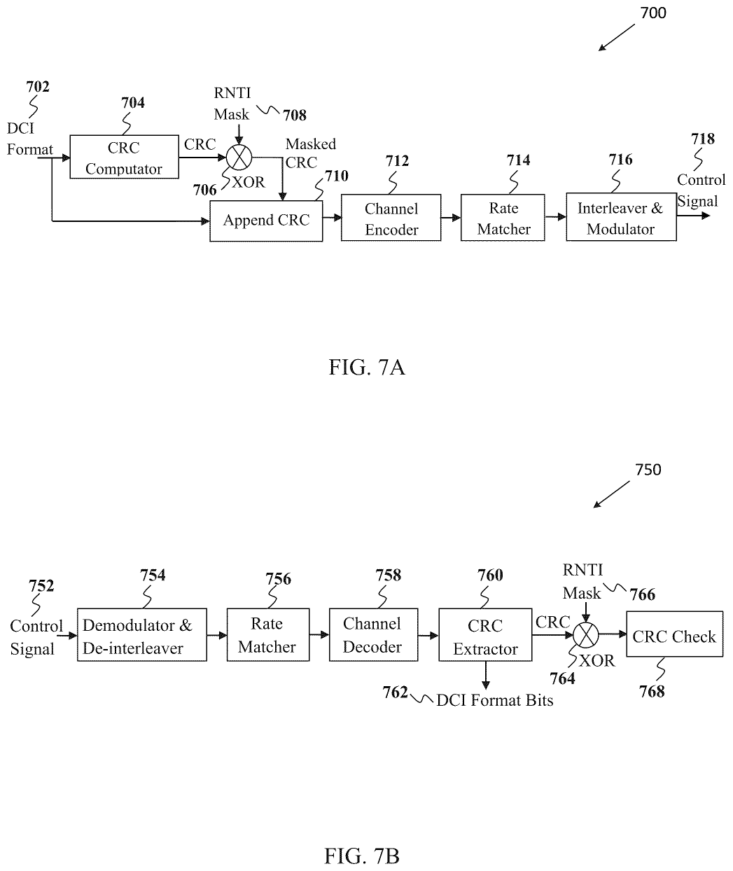

FIGS. 7A and 7B illustrate an example of an encoding and decoding processes 700 and 750, respectively, for DCI according to embodiments of the present disclosure. For example, encoding process 700 may be implemented by a BS 102 while decoding process 750 may be implemented by any of the UEs 111-116 of FIG. 1. This example is for illustration only and other embodiments can be used without departing from the scope of the present disclosure.

A gNB separately encodes and transmits each DCI format in a respective PDCCH. When applicable, a RNTI for a UE that a DCI format is intended for masks a CRC of the DCI format codeword in order to enable the UE to identify the DCI format. For example, the CRC can include 24 bits and the RNTI can include 16 bits or 24 bits. The CRC of (non-coded) DCI format bits 702 is determined using a CRC computation unit 704, and the CRC is masked using an exclusive OR (XOR) operation unit 706 between CRC bits and RNTI bits 708. The XOR operation is defined as XOR (0,0)=0, XOR (0,1)=1, XOR (1,0)=1, XOR (1,1)=0. The masked CRC bits are appended to DCI format information bits using a CRC append unit 710. An encoder 712 performs channel coding, such as polar coding, followed by rate matching to allocated resources by rate matcher 714. Interleaving and modulation units 716 apply interleaving and modulation, such as QPSK, and the output control signal 718 is transmitted.

A received control signal 752 is demodulated and de-interleaved by a demodulator and a de-interleaver 754. A rate matching applied at a gNB transmitter is restored by rate matcher 756, and resulting bits are decoded by decoder 758. After decoding, a CRC extractor 760 extracts CRC bits and provides DCI format information bits 762. The DCI format information bits are de-masked 764 by an XOR operation with a RNTI 766 (when applicable) and a CRC check is performed by unit 768. When the CRC check succeeds (check-sum is zero), the DCI format information bits are regarded to be valid. When the CRC check does not succeed, the DCI format information bits are regarded to be invalid.

For each DL bandwidth part (BWP) indicated to a UE in a serving cell, the UE (e.g., the UE 116) can be provided by higher layer signaling with P≤3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can expect use of a same DM-RS precoder, a number of consecutive symbols for the CORESET, a set of resource blocks (RBs) for the CORESET, CCE-to-resource element groups (REG) mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot indicating first symbol(s) of the CORESET within a slot for PDCCH monitoring, a duration of Tₛ<kₛ slots indicating a number of slots that the search space set s exists, a number of PDCCH candidates Mₛ^{(L)} per CCE aggregation level L, and an indication that search space set s is either a common search space (CSS) set or a UE-specific search space (USS) set. When search space set s is a CSS set, the UE monitors PDCCH for detection of DCI format 2_x, where x ranges from 0 to 7 as described in TS 38.212 [REF2] v17.4.0, or for DCI formats associated with scheduling broadcast/multicast PDSCH receptions, and for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number n_{s,f}^{μ} in a frame with number n_{f} if (n_{f}·Nₛₗₒₜ^{frame,μ}+n_{s,f}^{μ}−oₛ) mod kₛ=0. The UE monitors PDCCH candidates for search space set s for Tₛ consecutive slots, starting from slot n_{s,f}^{μ}, and does not monitor PDCCH candidates for search space set s for the next kₛ−Tₛ consecutive slots. The UE determines CCEs for monitoring PDCCH according to a search space set based on a search space equation as described in TS 38.213 [REF3] v17.4.0.

A UE expects to monitor PDCCH candidates for up to 4 sizes of DCI formats that include up to 3 sizes of DCI formats with CRC scrambled by C-RNTI per serving cell. The UE counts a number of sizes for DCI formats per serving/scheduled cell based on a number of PDCCH candidates in respective search space sets for the corresponding active DL BWP. In the following, for brevity, that constraint for the number of DCI format sizes will be referred to as DCI size limit. When the DCI size limit would be exceeded for a UE based on a configuration of DCI formats that the UE monitors PDCCH, the UE aligns the size of some DCI formats, as described in TS 38.212 [REF2] v17.4.0, so that the DCI size limit would not be exceeded.

For each scheduled cell, the UE is not required to monitor on the active DL BWP with SCS configuration μ of the scheduling cell more than min (M_{PDCCH}^{max,slot,μ}, M_{PDCCH}^{total,slot,μ}) PDCCH candidates or more than min (C_{PDCCH}^{max,slot,μ}, C_{PDCCH}^{total,slot,μ}) non-overlapped CCEs per slot, wherein M_{PDCCH}^{max,slot,μ} and C_{PDCCH}^{max,slot,μ} are respectively a maximum number of PDCCH candidates and non-overlapping CCEs for a scheduled cell and M_{PDCCH}^{total,slot,μ} and C_{PDCCH}^{total,slot,μ} are respectively a total number of PDCCH candidates and non-overlapping CCEs for a scheduling cell, as described in TS 38.213 [REF3] v17.4.0.

A UE does not expect to be configured CSS sets, other than CSS sets for multicast PDSCH scheduling, which result to corresponding total, or per scheduled cell, numbers of monitored PDCCH candidates and non-overlapped CCEs per slot on the primary cell that exceed the corresponding maximum numbers per slot. For USS sets or for CSS sets associated with multicast PDSCH scheduling, when a number of PDCCH candidates or non-overlapping CCEs in a slot would exceed the aforementioned limits/maximum per slot for scheduling on the primary cell, the UE selects the USS sets or the CSS sets to monitor corresponding PDCCH in an ascending order of a corresponding search space set index until and an index of a search space set for which PDCCH monitoring would result to exceeding the maximum number of PDCCH candidates or non-overlapping CCEs per slot for scheduling on the PCell as described in TS 38.213 [REF3] v17.4.0.

For same cell scheduling or for cross-carrier scheduling where a scheduling cell and scheduled cells have DL BWPs with same SCS configuration u, a UE does not expect a number of PDCCH candidates. A number of corresponding non-overlapped CCEs per slot on a secondary cell to be larger than the corresponding numbers that the UE is capable of monitoring on the secondary cell per slot. For cross-carrier scheduling, the number of PDCCH candidates for monitoring and the number of non-overlapped CCEs per slot are separately counted for each scheduled cell.

A UE can be configured for operation with carrier aggregation (CA) for PDSCH receptions over multiple cells (DL CA) or for PUSCH transmissions over multiple cells (UL CA). The UE can also be configured multiple transmission-reception points (TRPs) per cell via indication (or absence of indication) of a coresetPoolIndex for CORESETs where the UE receives PDCCH/PDSCH from a corresponding TRP as described in TS 38.213 v17.4.0 and TS 38.214 [REF4] v17.4.0.

MIMO technologies have a key role in boosting system throughput both in NR and LTE and such a role will continue and further expand in the future generations of wireless technologies.

For MIMO operation, an antenna port is defined such that a channel over which a symbol on the antenna port is conveyed can be inferred from the channel over which another symbol on the same antenna port is conveyed. There is not necessarily a one to one correspondence between an antenna port and an antenna element, and a plurality of antenna elements can be mapped onto one antenna port.

To enable digital precoding, it is important to provide an efficient design of CSI-RS in order to address various operating conditions while maintaining a low overhead for CSI-RS transmissions. For that reason, three types of CSI reporting mechanism corresponding to three types of CSI-RS measurement behavior are supported in Rel.13 LTE: 1) ‘CLASS A’ CSI reporting that corresponds to non-precoded CSI-RS, 2) ‘CLASS B’ CSI reporting with K=1 CSI-RS resource that corresponds to UE-specific beamformed CSI-RS, and 3) ‘CLASS B’ reporting with K>1 CSI-RS resources that corresponds to cell-specific beamformed CSI-RS. For non-precoded (NP) CSI-RS, a cell-specific one-to-one mapping between CSI-RS port and transmission rate unit (TXRU) is utilized. Here, different CSI-RS ports have the same wide beam width and direction and hence generally cell-wide coverage. For beamformed CSI-RS, beamforming operation, either cell-specific or UE-specific, is applied on a non-zero-power (NZP) CSI-RS resource including multiple ports. Here, at least at a given time/frequency resources, CSI-RS ports have narrow beam widths, and, hence, do not provide cell-wide coverage and (at least from the eNB perspective) at least some CSI-RS port-resource combinations have different beam directions. The basic principle remains same in NR.

In scenarios where a gNB can measure long-term DL channel statistics for a UE through receptions of signals from the UE, such as SRS or DM-RS, UE-specific beamformed CSI-RS can be readily used. This is typically feasible when UL-DL duplex distance is sufficiently small. When that condition does not hold, UE feedback is necessary for the gNB (e.g., the gNB 102) to obtain an estimate of long-term DL channel statistics (or any of its representation thereof). To facilitate such a procedure, a first beamformed CSI-RS transmitted with periodicity T1 (msec) and a second NP CSI-RS transmitted with periodicity T2 (msec), where T1≤T2. This approach is referred to as hybrid CSI-RS. The implementation of hybrid CSI-RS depends on the definition of CSI processes and NZP CSI-RS resources.

One important component of a MIMO transmission scheme is the accurate CSI acquisition at the gNB (or TRP). For multi-user (MU)-MIMO, in particular, availability of accurate CSI is necessary in order to guarantee robust MU performance and avoid interference among transmissions to different UEs. For time division duplexing (TDD) systems, CSI can be acquired using SRS transmissions from UEs by relying on DL/UL channel reciprocity. For frequency division duplexing (FDD) systems, a gNB can acquire CSI by transmitting CSI-RS and obtaining corresponding CSI reports from UEs. A CSI reporting framework can be ‘implicit’ in the form of channel quality indicator (CQI)/precoding matrix indicator (PMI)/rank indicator (RI), and CSI-RS resource indicator (CRI), as derived from a codebook expecting SU transmission from eNB. Because of the inherent SU expectation while deriving CSI, implicit CSI feedback is inadequate for MU transmissions. For MU-centric operation, a high-resolution Type-II codebook, in addition to low resolution Type-I codebook, can be used.

A serving gNB (such as the BS 102) can configure Type-I and Type-II CSI codebooks to a UE using higher layer signalling to provide a CodebookConfig IE, as described in TS 38.331 [REF5] v17.4.0, that includes the following parameters.
codebookType includes type1, type2 and sub-types such as type1-SinglePanel, type1-MultiPanel, typeII, and typeII-PortSelection, and corresponding parameters for each type.
n1-n2 configures a number of antenna ports in first (n1) and second (n2) dimension and codebook subset restriction for type1-SinglePanel.
ng-n1-n2 configures a number of antenna panels (ng), a number of antenna ports in first (n1) and second (n2) dimension expecting that the antenna structure is identical for the configured number of panels, and a codebook subset restriction for Type I Multi-panel codebook.
n1-n2-codebookSubsetRestriction configures a number of antenna ports in first (n1) and second (n2) dimension and a codebook subset restriction for typeII.
CodebookConfig-r17 includes type1-SinglePanel1-r17 and type1-SinglePanel2-r17 for type1 to enable configuration of different antenna structures for two TRPs.

The IE RS-ResourceMapping indicates a resource element mapping for a CSI-RS resource in the time and frequency domains. The container of the IE includes elements for configuration of time and frequency domain resources such as by firstOFDMSymbolIn Time Domain, firstOFDMSymbolIn TimeDomain2, and frequencyDomainAllocation, the CSI-RS density by density, the number of ports by nrofPorts, and others. The IE CSI-RS-ResourceMapping comprises the NZP-CSI-RS-Resource and ZP-CSI-RS-Resource configurations that are included in the CSI-ResourceConfig. The IE CSI-ResourceConfig defines a group of one or more NZP-CSI-RS-ResourceSet, CSI-IM-ResourceSet and/or CSI-SSB-ResourceSet.

The IE CSI-ReportConfig is used to indicate to a UE parameters for providing a periodic or semi-persistent CSI report via physical uplink control channel (PUCCH) transmissions on the cell where CSI-ReportConfig is included, or to indicate parameters for providing a semi-persistent or aperiodic CSI report on a PUSCH as triggered by a DCI that the UE receives. The CSI-ReportConfig is set for certain CSI-ResourceConfigId for channel/interference measurements. The aforementioned CodebookConfig is also part of CSI-ReportConfig.

For aperiodic CSI, both aperiodic CSI reporting and aperiodic CSI-RS transmission are triggered using a ‘CSI Request’ field within a DCI format scheduling a PUSCH transmission, such as DCI format 0_1. The ‘CSI Request’ field indicates a ‘Trigger State’ that points to a certain CSI-ReportConfigId and resourcesForChannel, e.g., NZP-CSI-RS-ResourceSet. The ‘CSI Request’ field can have up to 6 bits and can indicate up to 64 ‘Trigger States’. If a UE is configured with more than 64 ‘Trigger States’, a ‘Aperiodic CSI Trigger State Subselection’ MAC control element (CE) identifies a subset of Trigger States that are indicated by DCI.

For semi-persistent CSI (SP CSI-RS) on PUCCH, the semi-persistent CSI-RS resource is triggered by a “SP CSI-RS/CSI interference measurement (CSI-IM) Resource Set Activation/Deactivation” MAC CE that includes a SP CSI-RS resource set ID indicating an index of NZP-CSI-RS-ResourceSet containing Semi Persistent NZP CSI-RS resources indicating the Semi Persistent NZP CSI-RS resource set that is to be activated or deactivated. Semi-persistent CSI reporting on PUCCH is triggered using the “SP CSI reporting on PUCCH Activation/Deactivation” MAC CE. The field Sᵢ in the MAC CE indicates the activation/deactivation status of the Semi-Persistent CSI report configuration within csi-ReportConfigToAddModList. So refers to the report configuration that includes PUCCH resources for semi-persistent CSI reporting in the indicated BWP and has the lowest CSI-ReportConfigId within the list with type set to semiPersistentOnPUCCH. Sᵢ refers to the report configuration that includes PUCCH resources for semi-persistent CSI reporting in the indicated BWP and has the second lowest CSI-ReportConfigId, and so on.

For semi-persistent CSI reporting on PUSCH, a CSI report is triggered using a ‘CSI Request’ field in a DCI format 0_1 with CRC scrambled by a semi-persistent CSI-RNTI (SP-CSI-RNTI). The operating details are similar to those for an aperiodic CSI report.

For periodic CSI reporting, both reporting and periodic CSI-RS resources are configured and initiated by CSI-ReportConfig.

A UE is semi-statically configured by higher layers to perform periodic CSI reporting on the PUCCH. A UE can be configured by higher layers for multiple periodic CSI Reports corresponding to multiple higher layer configured CSI Reporting Settings, where the associated CSI Resource Settings are higher layer configured. Periodic CSI reporting on PUCCH formats 2, 3, 4 supports Type I CSI with wideband granularity.

A UE shall perform semi-persistent CSI reporting using PUCCH starting from the first slot that is after slot n+3Nₛₗₒₜ^{subframe,μ}, when the UE would transmit a PUCCH with hybrid automatic repeat request acknowledgement (HARQ-ACK) information in slot n corresponding to the PDSCH carrying the activation command described in clause 6.1.3.16 of [6] where u is the SCS configuration for the PUCCH. The activation command will contain one or more Reporting Settings where the associated CSI Resource Settings are configured. Semi-persistent CSI reporting on the PUCCH supports Type I CSI. Semi-persistent CSI reporting using PUCCH format 2 supports Type I CSI with wideband frequency granularity. Semi-persistent CSI reporting using PUCCH formats 3 or 4 supports Type I CSI with wideband and sub-band frequency granularities and Type II CSI Part 1.

When a PUCCH provides a Type I CSI report with wideband frequency granularity, the CSI payload is independent of PUCCH format 2, 3, or 4 and is same irrespective of RI (if reported), CRI (if reported). A CSI-ReportConfig with codebookType set to ‘type1-SinglePanel’ and a corresponding CSI-RS Resource Set for channel measurement configured with two Resource Groups and N Resource Pairs can be configured with wideband frequency granularity only with csi-ReportMode set to ‘Mode1’ and memberOfSingle TRP-CSI-Mode1 set to X=0. For type I CSI sub-band reporting on PUCCH formats 3, or 4, the payload is split into two parts. The first part contains RI (if reported), CRI (if reported), CQI for the first codeword. The second part contains PMI (if reported), LI (if reported) and contains the CQI for the second codeword (if reported) when RI>4. For a CSI-ReportConfig configured with subband reporting, codebookType set to ‘typeISinglePanel’and the corresponding CSI-RS Resource Set for channel measurement configured with two Resource Groups and N Resource Pairs, Part 1 contains RI(s), CRI(s), CQI(s) for the first codeword and is zero padded to a fixed payload size (if needed). Part 2 contains the CQI(s) for the second codeword (if reported) when RI is larger than 4, LIs (if reported) and PMI(s).

A semi-persistent report provided using PUCCH formats 3 or 4 supports Type II CSI report, but only Part 1 of Type II CSI report (See Clauses 5.2.2 and 5.2.3 of TS 38.214 v17.6.0). Supporting Type II CSI reporting on the PUCCH formats 3 or 4 is a UE capability type2-SP-CSI-Feedback-LongPUCCH. A Type II CSI report (Part 1 only) carried on PUCCH formats 3 or 4 shall be calculated independently of any Type II CSI reports carried on the PUSCH (see Clause 5.2.3 of TS 38.214 v17.6.0).

When the UE is configured with CSI Reporting on PUCCH formats 2, 3 or 4, each PUCCH resource is configured for each candidate UL BWP.

If the UE is in an active semi-persistent CSI reporting configuration on PUCCH and has not received a deactivation command, the CSI reporting takes place when the BWP in which the reporting is configured to take place is the active BWP. Otherwise, the CSI reporting is suspended.

A UE is not expected to report CSI with a total number of uplink control information (UCI) bits and CRC bits larger than 115 bits when configured with PUCCH format 4. For CSI reports transmitted on a PUCCH, if CSI reports include one part, the UE may omit a portion of CSI reports. Omission of CSI is according to the priority order determined from the Pri_{i,CSI} (y,k,c,s) value as defined in Clause 5.2.5 of TS 38.214 v17.6.0. CSI report is omitted beginning with the lowest priority level until the CSI report code rate is less or equal to the one configured by the higher layer parameter maxCodeRate.

If any of the CSI reports includes two parts, the UE may omit a portion of Part 2 CSI. Omission of Part 2 CSI is according to the priority order shown in Table 5.2.3-1 of TS 38.214 v17.6.0. Part 2 CSI is omitted beginning with the lowest priority level until the Part 2 CSI code rate is less or equal to the one configured by higher layer parameter maxCodeRate.

A UE shall perform aperiodic CSI reporting using PUSCH on serving cell c upon successful decoding of a DCI format, such as DCI format 0_1 or DCI format 0_2, which triggers an aperiodic CSI trigger state.

When a DCI format, such as DCI format 0_1, schedules two PUSCH allocations, the aperiodic CSI report is provided on the second scheduled PUSCH. When a DCI format schedules more than two PUSCH allocations, the aperiodic CSI report is carried on the penultimate scheduled PUSCH.

An aperiodic CSI report carried on the PUSCH supports wideband, and sub-band frequency granularities. An aperiodic CSI report carried on the PUSCH supports Type I, Type II, Enhanced Type II and Further Enhanced Type II Port Selection CSI.

A UE shall perform semi-persistent CSI reporting on a PUSCH upon successful decoding of a DCI format, such as DCI format 0_1 or DCI format 0_2, which activates a semi-persistent CSI trigger state. The DCI format contains a CSI request field which indicates the semi-persistent CSI trigger state to activate or deactivate. Semi-persistent CSI reporting on the PUSCH supports Type I, Type II with wideband, and sub-band frequency granularities, Enhanced Type II and Further Enhanced Type II Port Selection CSI. The PUSCH resources and MCS are allocated semi-persistently by the DCI format.

A CSI report can be multiplexed with data information on a PUSCH except that a semi-persistent CSI report on a PUSCH activated by a DCI format is not expected to be multiplexed with data information on the PUSCH.

Type I CSI report is supported for CSI Reporting on PUSCH. Type I wideband or sub-band CSI report is supported for CSI reporting on the PUSCH. Type II CSI report is supported for CSI reporting on the PUSCH.

For Type I, Type II, Enhanced Type II and Further Enhanced Type II Port Selection CSI report on PUSCH, a CSI report comprises of two parts. Part 1 has a fixed payload size and is used to identify the number of information bits in Part 2. Part 1 shall be transmitted in its entirety before Part 2.

For Type I CSI report, Part 1 contains RI (if reported), CRI (if reported), CQI for the first codeword (if reported). Part 2 contains PMI (if reported), LI (if reported) and contains the CQI for the second codeword (if reported) when RI is larger than 4. For a CSI-ReportConfig configured with codebookType set to ‘typeISinglePanel’ and the corresponding CSI-RS Resource Set for channel measurement configured with two Resource Groups and N Resource Pairs, Part 1 contains RI(s), CRI(s), CQI(s) for the first codeword and is zero padded to a fixed payload size (if needed). Part 2 contains the CQI(s) for the second codeword (if reported) when RI is larger than 4, LIs (if reported) and PMI(s).

For Type II CSI report, Part 1 contains RI (if reported), CQI, and an indication of the number of non-zero wideband amplitude coefficients per layer for the Type II CSI (see Clause 5.2.2.2.3 of TS 38.214 v17.6.0). The fields of Part 1-RI (if reported), CQI, and the indication of the number of non-zero wideband amplitude coefficients for each layer—are separately encoded. Part 2 contains the PMI and LI (if reported) of the Type II CSI. The elements of i_{1,4,l}, i_{2,1,l} (if reported) and i_{2,2,l} (if reported) are reported in increasing order of their indices, i=0,1, . . . , 2L−1, where the element with the lowest index is mapped to the most significant bits and the element with the highest index is mapped to the least significant bits. Part 1 and 2 are separately encoded.

For Enhanced Type II CSI report (see Clause 5.2.2.2.5 of TS 38.214 v17.6.0) and Further Enhanced Type II Port Selection CSI report (see Clause 5.2.2.2.7 of TS 38.214 v17.6.0), Part 1 contains RI (if reported), CQI, and an indication of the overall number of non-zero amplitude coefficients across layers. The fields of Part 1-RI (if reported), CQI, and the indication of the overall number of non-zero amplitude coefficients across layers—are separately encoded. Part 2 contains the PMI of the Enhanced Type II or Further Enhanced Type II Port Selection CSI. Part 1 and 2 are separately encoded.

A Type II CSI report that is carried on the PUSCH shall be computed independently from any Type II CSI report that is provided using PUCCH formats 3 or 4 (see Clause 5.2.4 and 5.2.2 of TS 38.214 v17.6.0).

When reportQuantity is configured with one of the values ‘cri-RSRP’, ‘ssb-Index-RSRP’, ‘criSINR’ or ‘ssb-Index-SINR’, or ‘cri-RSRP-Capability [Set] Index’, ‘ssb-Index-RSRP-Capability [Set] Index’, ‘cri-SINRCapability [Set] Index’, ‘ssb-Index-SINR-Capability [Set] Index’, the CSI report includes a single part.

For both Type I and Type II reports configured for PUCCH but transmitted on PUSCH, the determination of the payload for CSI part 1 and CSI part 2 follows that of PUCCH as described in Clause 5.2.4 of TS 38.214 v17.6.0.

When a CSI report on PUSCH comprises two parts, the UE may omit a portion of the Part 2 CSI. Omission of Part 2 CSI is according to the priority order shown in Table 5.2.3-1 of TS 38.214 v17.6.0, where N_{Rep} is the number of CSI reports configured to be provided on the PUSCH. Priority 0 is the highest priority and priority 2N_{Rep} is the lowest priority and the CSI report n corresponds to the CSI report with the nth smallest Pri_{i,CSI} (y,k,c,s) value among the N_{Rep} CSI reports as defined in Clause 5.2.5 of TS 38.214 v17.6.0. The subbands for a given CSI report n indicated by csi-ReportingBand are numbered continuously in increasing order with the lowest subband of csi-ReportingBand as subband 0. When omitting Part 2 CSI information for a particular priority level, the UE shall omit all of the information at that priority level.

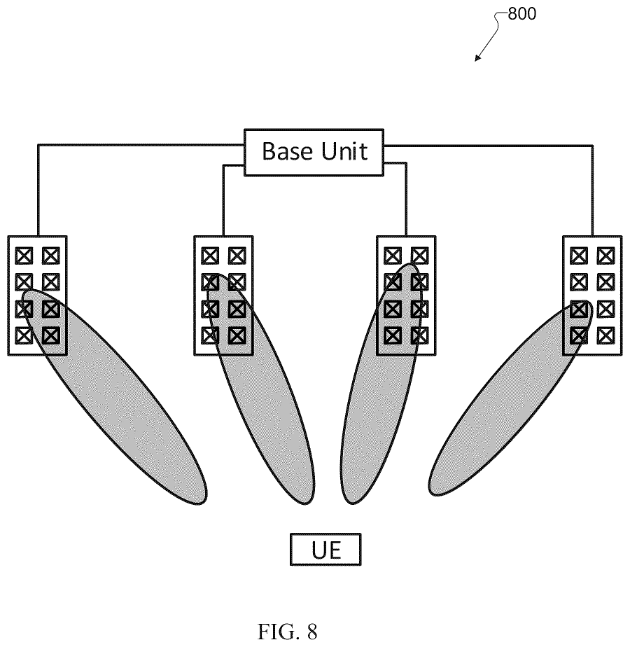

FIG. 8 illustrates an example system 800 of a cooperative mTRP according to embodiments of the present disclosure. For example, the system 800 may operate within the wireless network 100 in FIG. 1. This example is for illustration only and other embodiments can be used without departing from the scope of the present disclosure.

The number of antenna elements that can be integrated on a practically feasible antenna size can be restrictive at lower frequency bands due to the half-wavelength distancing needed between antenna elements to decorrelate the channel property. This motivates a distributed MIMO system, wherein multiple TRPs cooperatively beamform channels or signals for joint transmissions or receptions. In addition to supporting a larger number of antenna elements, the mTRP cooperative communication system can be beneficial in achieving spatial diversity gain or improving system reliability from a single point of failure. In FIG. 8, the mTRPs can be collocated in one site or can be non-collocated. For coherent joint transmission (CJT), distributed antenna ports at different TRPs can form one logical baseband antenna system at the Base Unit. The Base Unit is a logical concept and can reside in a distributed unit (DU) or centralized unit (CU) in a disaggregated RAN deployment.

To operate distributed antennas jointly as a single logical antenna system with non-overlapped antenna port mapping among mTRPs, the CSI report framework, such as Type-I or Type-II codebook design, needs to be enhanced. In one approach, a CSI-RS resource set can include a number of CSI-RS resources, each corresponding to different TRPs, as illustrated in FIG. 8, and they collectively comprise a single logical set of antenna ports. As an example, a UE is configured with N_{TRP} CSI-RS resources having a same number of ports, Nₚₒᵣₜ, and a total number of CSI-RS ports is given by N_{TRP} times Nₚₒᵣₜ. A set of codebook parameters, such as a codebook size, N₁-N₂, can be commonly configured for N_{TRP} CSI-RS resources within the resource set. In another example, a UE is configured with N_{TRP} CSI-RS resources each with a different number of antenna ports, and a total number of CSI-RS ports is given by the summation of the different number of antenna ports across TRPs. In this example, a set of codebook parameters, such as N₁-N₂, can be separately configured for N_{TRP} CSI-RS resources within the resource set.

In one Type-II codebook enhancement to support coherent joint transmission (CJT), spatial domain basis is selected per TRP, i.e., W_{l,i} for i-th TRP, coefficient component W₂ is calculated across the TRPs, and the frequency domain basis W_{f} is selected as TRP common for the TRPs in the configured set of N TRPs. Based on CSI reporting from a UE, the base station transmit antenna precoding matrix can be reconstructed as follows.

$$W = [ \begin{matrix}{W}_{1 , 1} {\tilde{W}}_{2 , 1} {W}_{f}^{H} \\ ⋮ \\ {W}_{1 , N} {\tilde{W}}_{2 , N} {W}_{f}^{H}\end{matrix} ]$$

Reporting TRP common frequency domain basis W_{f} can be suitable for a collocated mTRP scenario in which the channels from different TRPs to a UE can experience similar multi-path delay profile. In another Type-II codebook enhancement to support CJT, the frequency domain basis can be selected per TRP, i.e., W_{f,i} for i-th TRP, such as by reporting frequency domain relative offset Qᵢ for i-th TRP. In this case, the precoding matrix can be reconstructed as follows.

$$W = [ \begin{matrix}{W}_{1 , 1} {{\tilde{W}}_{2 , 1} ( {Q}_{1} {W}_{f} )}^{H} \\ ⋮ \\ {W}_{1 , N} {{\tilde{W}}_{2 , N} ( {Q}_{N} {W}_{f} )}^{H}\end{matrix} ]$$

Reporting TRP-specific frequency domain basis can be suitable for a non-collocated mTRP scenario in which it is atypical that the channels from different TRPs to a UE will experience similar multi-path delay profile.

In Type-I codebook, the precoding matrix is expressed as W=W₁W₂, where W₁ provides a single spatial domain basis selection or a set of neighboring bases, which are non-orthogonal depending on the codebook mode. W₂ provides co-phase feedback for cross-polarized antenna ports and, additionally, beam selection indication if W₁ includes multiple spatial domain bases. An enhancement to Type-I codebook to support CJT can be also similarly exemplified. In one example, the spatial domain basis is selected per TRP, e.g., Wii for i-th TRP, while W₂ is calculated across the TRPs. In another example, the spatial domain basis W₁ is selected as TRP common while W₂ is calculated across the TRPs. Additionally, TRP specific offset to W₁ can be reported by the UE.

In one approach, UE selection of a subset of TRPs for CSI reporting can be performed prior to calculating CSI report quantities. This may be because a channel between a UE and a particular TRP is in a bad condition, such as blockage, relative to channels between the UE (e.g., the UE 116) and other TRPs. Therefore, it may be beneficial to exclude such TRP experiencing dissimilar channel conditions from other TRPs for CJT to avoid overall system performance degradation, e.g., for throughput. With selection of a subset of TRPs, the CSI reporting is not for N=N_{TRP} CSI-RS resources but for a subset of CSI-RS resources corresponding to the selected subset of TRPs. When TRP selection is performed, a UE can report indexes of TRPs, or equivalently CSI-RS resource indexes, whose CSI is reported using, e.g., a bitmap of size N_{TRP}.

Present networks have limited capability to adapt an operation state in one or more of time/frequency/spatial/power domains. For example, in NR, there are transmissions or receptions on a cell by a serving gNB that are expected by UEs, such as transmissions of synchronization signals/physical broadcast channel (SS/PBCH) blocks, or of system information, or of CSI-RS indicated by higher layers, or receptions of physical random access channel (PRACH) or sounding reference signal (SRS) indicated by higher layers. Reconfiguration of a network (NW) operation state involves higher layer signaling by a system information block (SIB) or by UE-specific RRC. That is a slow process and requires substantial signaling overhead, particularly for UE-specific RRC signaling. For example, it is currently not practical or possible for a network in typical deployments to enter an energy saving operation state where the network (e.g., the network 130) does not transmit or receive due to low traffic on a cell as, in order to obtain material energy savings, the network needs to suspend transmissions or receptions for several tens of milliseconds and preferably for even longer time periods. A similar inability exists for suspending transmission or receptions on a cell for shorter time periods as a serving gNB may need to frequently transmit SS/PBCH blocks on the cell, such as every 5 msec or every 20 msec and, in time division duplex (TDD) systems with UL-DL configurations having few UL symbols in a period, the serving gNB may need to receive PRACH or SRS on the cell in most UL symbols in a period.

Due to the reasons herein, adaptation of a NW operation state on a cell is typically over long time periods, such as for off-peak hours when an amount of served traffic is small and for peak hours when an amount of served traffic is large. Therefore, a capability of a gNB to improve service by fast adaptation of a NW operation state to the traffic types and load on a cell, or to save energy by switching to an operation state that requires less energy consumption when an impact on service quality would be limited or none on a cell, is currently limited as there are no procedures for a serving gNB to perform fast adaptation of a NW operation state with small signaling overhead while simultaneously informing UEs of the NW operation state for a cell.

It is also beneficial to support a gradual transition of NW operation states on a cell between a maximum state where the cell operates at its maximum capability in one or more of a time/frequency/spatial/power domain and a minimum state where the cell operates at its minimum capability, or the cell enters a sleep mode. That would allow continuation of service while the cell transitions from a state with larger utilization of time/frequency/spatial/power resources to a state with lower utilization of such resources and the reverse as UEs can obtain time/frequency synchronization and AGC alignments, perform measurements, and provide CSI reports or transmit SRS prior to scheduling of PDSCH receptions or PUSCH transmissions.

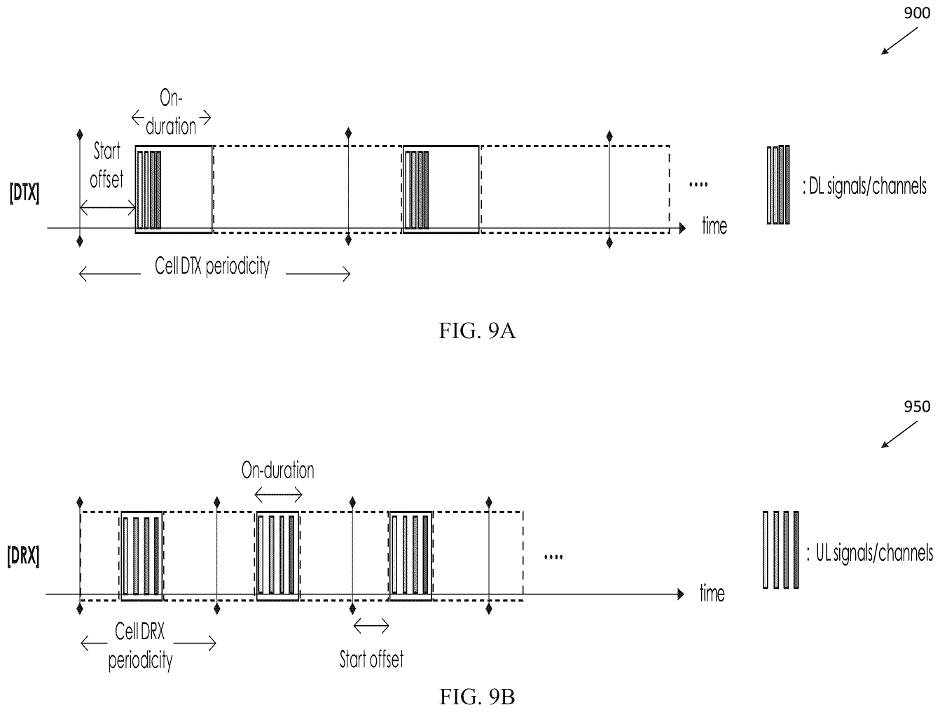

FIGS. 9A and 9B illustrate timelines for example cell DTX and DRX 900 and 950, respectively, according to embodiments of the present disclosure. For example, DTX 900 and DRX 950 can be followed by the BS 102 of FIG. 1. This example is for illustration only and other embodiments can be used without departing from the scope of the present disclosure.

In order to enable a gNB to operate a cell on sleep state and save energy while minimizing an impact on served UEs on the cell, the gNB (e.g., the gNB 102) can apply discontinued transmissions (cell DTX) or discontinued receptions (cell DRX) on the cell. A UE can be informed of corresponding cell DTX/DRX configurations for a cell such that the UE can operate accordingly and avoid power consumption when the cell is in a dormant state (cell DTX/DRX). By turning off (each) part of a transmission chain and pausing transmission during the cell DTX, the gNB can reduce energy consumption for standby when there is little to no traffic on a cell.

For cell DTX, a UE may expect that transmissions from a serving gNB on the cell are suspended or the UE may expect that some signals, such as primary synchronization signal (PSS) or secondary synchronization signal (SSS) for maintaining synchronization, remain present during cell DTX. By turning off (each) part of receiver chain and pausing receptions during the cell DRX, the gNB can reduce energy consumption for standby on a cell when there is little to no traffic on the cell. For cell DRX, a UE may expect that transmissions from the UE on a cell are suspended or may expect that some transmissions, such as ones required for initial access such as PRACH, are allowed during a cell DRX duration.

With reference to FIGS. 9A and 9B, cell DTX/DRX can be configured via at least a periodicity, a start slot/offset, and an on-duration. A UE expects that transmissions/receptions by the gNB on a cell are enabled during the DTX/DRX on-duration, respectively. The configurations and operations of cell DTX and cell DRX can be linked or can be separate, for example depending on DL/UL traffic characteristics on the cell.

The energy consumption by power amplifiers (PA) for each set of antenna elements (AEs) accounts for a large portion of total energy consumption by a gNB equipped with massive MIMO antennas. For network energy savings, when the traffic load is low, the gNB can turn off a subset of PAs or reduce the PA output power levels on one or more cells. For brevity, such operation is respectively referred to as spatial domain (SD) or power domain (PD) adaptation in this disclosure. Unlike cell DTX/DRX illustrated in FIGS. 9A and 9B, one advantage of SD/PD adaptation is that the network can maintain continuity of transmissions and receptions on a cell without interruptions by operating at a reduced capability.

A gNB can enable/disable AEs associated to a logical antenna port or enable/disable a subset of AEs associated to a logical antenna port for transmissions on a cell. For brevity, those adaptations of AEs are respectively referred to as Type 1 and Type 2 SD adaptations in this disclosure. The gNB may perform Type 1 SD adaptation, or Type 2 SD adaptation, or both.

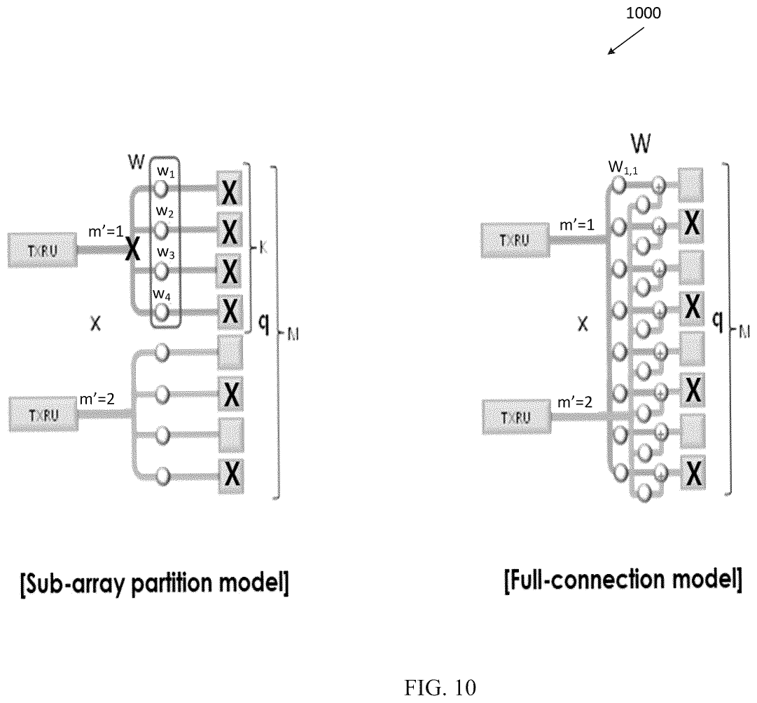

FIG. 10 illustrates diagrams of example spatial domain adaptations 1000 according to embodiments of the present disclosure. For example, spatial domain adaptations 1000 can be implemented by the BS 103 of FIG. 1. This example is for illustration only and other embodiments can be used without departing from the scope of the present disclosure.

In a hybrid beamforming system as illustrated in FIG. 5, one antenna port is connected to a large number of AEs that can be controlled by a bank of analog phase shifters, which is referred to as TxRU virtualization. The TxRU virtualization can be implemented based on sub-array partition model, full-connection model, or combinations of them, as illustrated in FIG. 10. In a sub-array partition model, spatial element adaptations can result in both Type 1 and Type 2 SD adaptations. In case of Type 1 SD adaptation, both the PAs connected to AEs associated to a logical antenna port and the subsequent RF chain, e.g., ADC/DAC, etc., associated to the logical antenna port can be turned off. In a full-connection model, spatial element adaptations can only result in Type 2 SD adaptations unless the antenna ports are turned off.

The impact of Type 1 SD adaptation results in a change in a number of active antenna ports or antenna structure in general. The RF characteristics, e.g., radiation power, beam pattern, etc., of remaining antenna ports remain same. The impact of Type 2 SD adaptation results in a change in the RF characteristics of antenna ports affected by AE on/off while the number of antenna ports remains the same. The impact of PD adaptation is similar to Type 2 SD adaptation. A gNB can perform any combination of Type 1 SD, Type 2 SD, and PD adaptations on a cell, together with other time/frequency domain adaptation techniques such as cell DTX/DRX.

Network operation parameters for transmission or reception on a cell can be in one or more of a power, spatial, time, or frequency domain.

For example, in power domain, a first NW operation state for a cell can be associated with a first value of parameter ss-PBCH-BlockPower providing an average energy per resource element (EPRE) with secondary synchronization signals (SSS) in dBm, and a second NW operation state can be associated with a second value of a parameter ss-PBCH-BlockPower. For example, first and second NW operation states for a cell can be respectively associated with first and second values of parameter powerControlOffsetSS that provides a power offset (in dB) of non-zero power (NZP) CSI-RS RE to SSS RE. For example, first and second NW operation states for a cell can be respectively associated with first and second values of parameter powerControlOffset that provides a power offset (in dB) of PDSCH RE to NZP CSI-RS RE.

For example, in frequency domain, first and second NW operation states for a cell can be respectively associated with first and second values of a parameter locationAndBandwidth that indicates a frequency domain location and a bandwidth for receptions or transmissions by a UE on the cell. For example, first and second NW operation states for a cell can be respectively associated with first and second values of a parameter BWP-Id for an active DL BWP or an active UL on the cell. For example, first and second NW operation states can be respectively associated with first and second values of a list of cells for active transmission and reception. The cells can be serving cells or non-serving cells for example in case of mobility.

For example, in spatial domain, first and second NW operation states for a cell can be respectively associated with first and second values of a parameter maxMIMO-Layers that indicates a maximum number of MIMO layers to be used for PDSCH receptions by a UE in the associated active DL BWP of the cell, or with first and second values of a parameter nrOfAntennaPorts that indicates a number of antenna ports to be used for codebook determination for PDSCH receptions on the cell, or with first and second values of a parameter activeCoresetPoolIndex for coresetPoolIndex values for PDCCH reception in corresponding CORESETs on the cell and the UE can skip PDCCH receptions in a CORESET with a coresetPoolIndex value that is not indicated by activeCoresetPoolIndex. For example, first and second NW operation states for a cell can be respectively associated with first and second values of an antenna port subset that indicates a list of active antenna ports for CSI calculation and other associated parameters such as codebook subset restriction, rank restriction, the logical antenna size in two-dimension, number of antenna ports, and a list of CSI-RS resources, etc., for the cell.

For example, in time domain, first and second NW operation states for a cell can be respectively associated with first and second values of a parameter ssb-PeriodicityServingCell that indicates a transmission periodicity in milliseconds for SS/PBCH blocks on the cell, or with first and second values of a parameter ssb-PositionsInBurst that indicates time domain positions of SS/PBCH blocks in a SS/PBCH block transmission burst on the cell, or with first and second values of a parameter groupPresence that indicates groups of SS/PBCH blocks, such as groups of four SS/PBCH blocks with consecutive indexes, that are transmitted on the cell. For example, first and second NW operation states for a cell can be respectively associated with first and second values of a time pattern, e.g., in terms of periodicity, on-duration, start offset, etc., that indicates cell discontinuous transmission (DTX) or cell discontinuous reception (DRX) for the cell.

Embodiments of the present disclosure recognizes that a network may need to assess an impact of adapting network transmission or reception parameters on a cell in one or more of a power, spatial, time, or frequency domain, such as turning on or off a subset of TRPs from a set of TRPs for the cell, prior to executing an actual adaptation by providing multiple CSI report sub-configurations for the cell, which correspond to different hypotheses of an active set of TRPs on the cell, to a UE and receiving multiple CSI reports from the UE. To provide multiple CSI report sub-configurations, which correspond to different set of active TRPs for a cell, there is a need for defining procedures and methods to associate a subset of CSI-RS resources from the resource set with a report sub-configuration to request CSI for CJT from the corresponding set of active TRPs for the cell. When a UE calculates a CSI report for a cell, there is another need for defining procedures and methods for CSI-RS antenna port mapping and deriving CSI report quantities for CJT from active TRPs on the cell.

A number of CSI report sub-configurations may also correspond to different Type-1 SD adaptation hypotheses with different number of active antenna ports from mTRPs of a cell. Thus, the CSI report sub-configurations can be further associated with a subset of antenna ports from the set of antenna ports transmitted in the CSI-RS resources in the resource set. To provide CSI report sub-configurations corresponding to different Type-1 SD adaptation hypotheses, there is a need for defining procedures and methods to indicate a subset of antenna ports from the set of TRPs of the cell. Also, there is another need for defining procedures and methods for CSI-RS antenna port mapping and deriving CSI report quantities for CJT when the number of CSI-RS antenna ports from CSI-RS resources changes on the cell.

A number of CSI report sub-configurations may also correspond to different Type-2 SD adaptation hypotheses with different number of spatial elements comprising antenna ports for CSI-RS transmission from TRPs of a cell. To provide CSI report sub-configurations corresponding to different Type-2 SD adaptation hypotheses, there is a need for defining procedures and methods to associating a different set of CSI-RS resources from the resource set to assess the impact on CJT with different antenna configurations at the TRPs of the cell.

The disclosure relates to a communication system.

The disclosure relates to defining functionalities and procedures for reporting CSI for CJT from mTRPs of a cell that is associated with multiple network operating states for the cell (adaptation hypotheses or cell operation states) in one or more of a power, spatial, time, or frequency domain, for example in order to support network energy savings for the cell.

The disclosure further relates to obtaining CSI for CJT from mTRPs of a cell corresponding to a hypothesis of TRP on/off adaptations on the cell.

The disclosure also relates to obtaining CSI for CJT from mTRPs of a cell corresponding to a hypothesis of Type-1 SD adaptations of TRPs of the cell.

The disclosure is further related to obtaining CSI for CJT from mTRPs of a cell corresponding to a hypothesis of Type-2 SD adaptations of TRPs of the cell.

The disclosure relates to a communication system. The disclosure relates to defining functionalities and procedures for reporting CSI that is associated with multiple network operating states (adaptation hypotheses) in one or more of a power, spatial, time, or frequency domain, for example in order to support network energy savings.

The disclosure further relates to associating a first number of CSI-RS resources with a second number of CSI report sub-configurations, calculating CSI for a third number of CSI report sub-configurations, providing the CSI report, and counting CPU.

The disclosure also relates to associating a first number of CSI-RS resources and a second number of transmission power adaptation values with a third number of CSI report sub-configurations, calculating CSI for a fourth number of CSI report sub-configurations and fifth number of transmission power adaptation values, providing the CSI report, and counting CPU.

The disclosure is further related to determining a first number of CSI reports from a second number of CSI report sub-configurations for a PUCCH resource, while satisfying the maximum code rates for UCI reporting using the PUCCH resource, along with CSI dropping rules in order to satisfy the maximum code rates requirements.

A description of example embodiments is provided on the following pages.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

The below flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Embodiments of the disclosure for reporting CSI for CJT from mTRPs of a cell associated with multiple network operating states (adaptation hypotheses or cell operation states) in one or more of a power, spatial, time, or frequency domain, for example in order to support network energy savings for the cell, are summarized in the following and are fully elaborated further herein.
Method and apparatus for obtaining CSI for CJT from mTRPs of a cell corresponding to a hypothesis of TRP on/off adaptations on the cell.
Method and apparatus for obtaining CSI for CJT from mTRPs of a cell corresponding to a hypothesis of Type-1 SD adaptations of TRPs on the cell.
Method and apparatus for obtaining CSI for CJT from mTRPs of a cell corresponding to a hypothesis of Type-2 SD adaptations of TRPs on the cell.

A detailed description of systems and methods consistent with embodiments of the present disclosure is provided herein. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or each of these details. Moreover, for the purpose of clarity, certain technical material that is known in the related art has not been described in detail in order to avoid unnecessarily obscuring the disclosure.

A UE can be indicated by a serving gNB a number of hypotheses on activation/deactivation of TRPs from a set of TRPs on a cell and the UE can provide a number of CSI reports according to the indicated hypotheses that correspond to a different set of active TRPs on the cell. A CSI report configuration provided to the UE can include a number of sub-configurations associated with network operation states (or cell operation states) which correspond to different hypotheses of mTRP on/off on the cell. Each CSI report sub-configuration can be further associated with a hypothesis on the operation parameters for transmission or reception in one or more of a power, spatial, time, or frequency domain on the cell, where the parameters may be indicated and applied per-TRP or commonly across mTRPs of the cell.

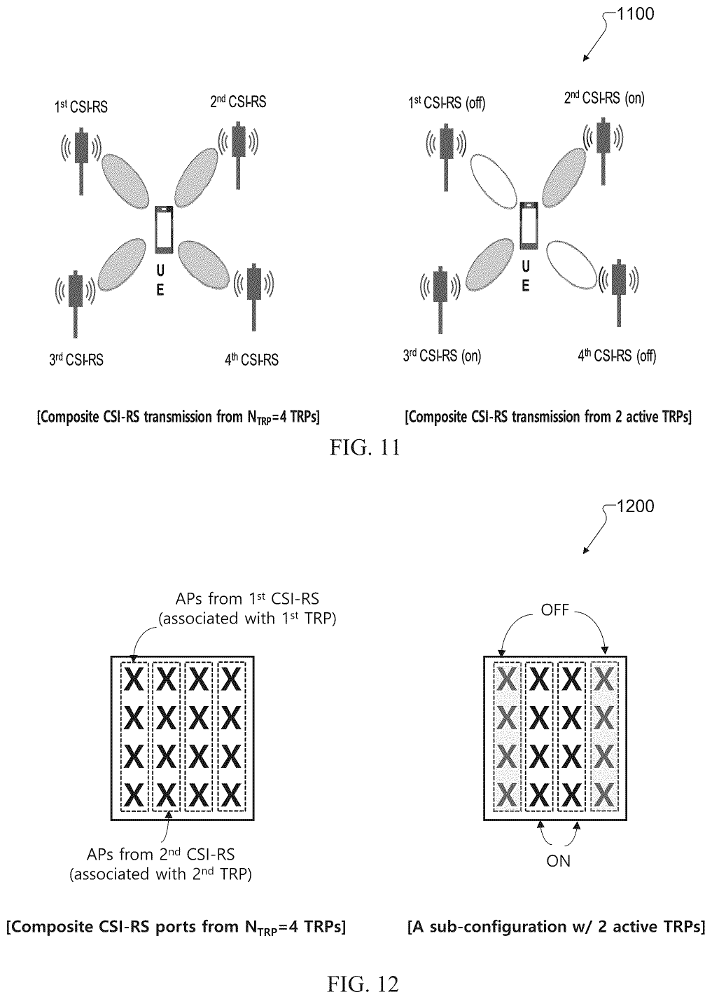

The left-hand side of FIG. 11 illustrates a composite CSI-RS transmission from N_{TRP}=4 TRPs of a cell. To measure and report CSI for C-JT from mTRPs, a UE can be provided a CSI-RS resource set including a number of CSI-RS resources, each corresponding to different TRPs of the cell as illustrated in the figure. The UE then calculates CSI for a set of antenna ports from N_{TRP}=4 CSI-RS resources provided in the resource set collectively. If N_{TRP} CSI-RS resources provide the same number of antenna ports, Nₚₒᵣₜ, the UE reports CSI for N_{TRP}·Nₚₒᵣₜ CSI-RS ports, if UE selection of a subset of TRPs of the cell is not considered.

The right-hand side of FIG. 11 illustrates an example hypothesis in which the first and the fourth TRPs of a cell are turned off, while the second and third TRPs of the cell remain turned on. In order for the UE to report CSI for this example hypothesis, the UE can be indicated to calculate CSI for a set of antenna ports from the second and the third CSI-RS resources only from the resource set on the cell.

FIG. 11 illustrates diagrams of example mTRP on/off adaptations 1100 according to embodiments of the present disclosure. For example, mTRP on/off adaptations 1100 may be implemented by the BS 102 of FIG. 2. This example is for illustration only and other embodiments can be used without departing from the scope of the present disclosure.

The general principle of CSI-RS port ordering can be done for example as follows: (CSI-RS resource #1, port #1), (CSI-RS resource #1, port #2), . . . , (CSI-RS resource #1, port #Nₚₒᵣₜ), . . . , (CSI-RS resource #N_{TRP}, port #1), (CSI-RS resource #N_{TRP}, port #2), . . . , (CSI-RS resource #N_{TRP}, port #Nₚₒᵣₜ) without TRP on/off adaptation on a cell. With reference to the left-hand side of FIG. 11, N_{TRP}=4 and P=8. The right-hand side of FIG. 11 illustrates CSI-RS antenna port mapping for a hypothesis where only the second and the third TPRs are turned on for the cell. In this scenario, the CSI-RS port ordering can be done as follows: (CSI-RS resource #2, port #1), (CSI-RS resource #2, port #2), . . . , (CSI-RS resource #2, port #8), (CSI-RS resource #3, port #1), (CSI-RS resource #3, port #2), . . . , (CSI-RS resource #3, port #8).

FIG. 12 illustrates a diagram of an example CSI-RS antenna port mapping 1200 with mTRP on/off adaptation according to embodiments of the present disclosure. For example, CSI-RS antenna port mapping 1200 with mTRP on/off adaptation can be implemented by BS 102 and/or BS 103 of FIG. 1. This example is for illustration only and other embodiments can be used without departing from the scope of the present disclosure.

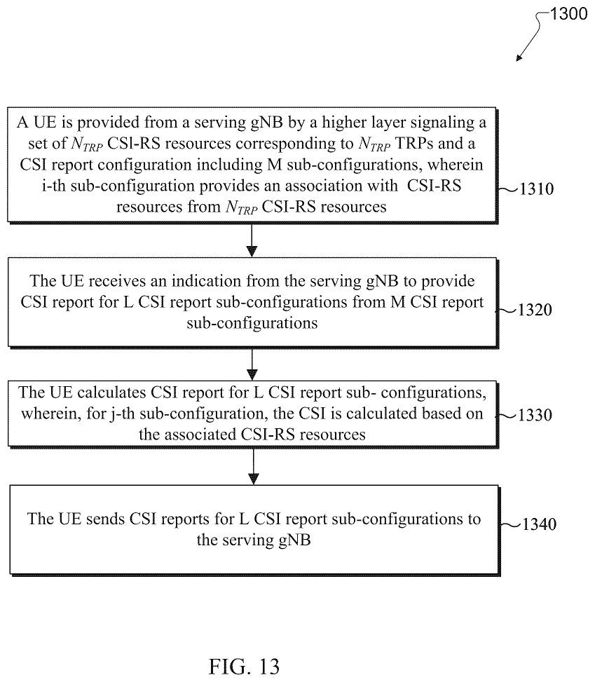

FIG. 13 illustrates a flowchart of an example UE procedure 1300 for reporting CSI for CJT from mTRP with on/off adaptations according to embodiments of the present disclosure. For example, procedure 1300 for reporting CSI for CJT from mTRP with on/off adaptations may be performed by any of the UEs 111-116 of FIG. 1, such as the UE 116 of FIG. 3. This example is for illustration only and other embodiments can be used without departing from the scope of the present disclosure.

The procedure begins in 1310, a UE is provided from a serving gNB by a higher layer signaling a set of N_{TRP} CSI-RS resources corresponding to N_{TRP} TRPs and a CSI report configuration including M sub-configurations, wherein i-th sub-configuration provides an association with N_{TRP}ⁱ CSI-RS resources from N_{TRP} CSI-RS resources. In 1320, the UE receives an indication from the serving gNB to provide CSI report for L CSI report sub-configurations from M CSI report sub-configurations. In 1330, the UE calculates CSI report for L CSI report sub-configurations, wherein, for j-th sub-configuration, the CSI is calculated based on the associated N_{TRP}^{j} CSI-RS resources. In 1340, the UE sends CSI reports for L CSI report sub-configurations to the serving gNB.

In 1310, a UE is provided from a serving gNB by a higher layer signaling a set of N_{TRP} CSI-RS resources corresponding to N_{TRP} TRPs of a cell and a CSI report configuration including M sub-configurations, wherein i-th sub-configuration provides an association with N_{TRP}ⁱ CSI-RS resources from N_{TRP} CSI-RS resources for the cell. The higher layer signaling can be an RRC information element (IE). The set of N_{TRP} CSI-RS resources and the CSI report configuration including M sub-configurations may also be updated by a MAC CE that indicates corresponding subsets of the ones provided in the RRC IE.

A UE is provided an association of N_{TRP}ⁱ CSI-RS resources from the N_{TRP} CSI-RS resources with i-th CSI report sub-configuration for a cell, where the list of CSI-RS resources corresponds to a set of active TRPs from N_{TRP} TRPs of the cell.

Each CSI report sub-configuration provides a list of active CSI-RS resource indexes from the set of CSI-RS resources in the resource set and corresponding codebook configuration for the set of active CSI-RS resources on a cell. In one example, N_{TRP} CSI-RS resources have a same number of CSI-RS ports and common codebook configuration, such as the codebook size N₁-N₂, paramCombination providing (L, pᵥ, β), which are a number of spatial domain basis vectors, a number of frequency domain basis vectors, and a parameter related to the maximum number of non-zero coefficients in W₂, memberOfPMI-SubbandsPerCQI-Subband, codebook subset restriction, rank restriction, etc. In this case, the number of CSI-RS ports associated with i-th sub-configuration is given by N_{TRP}ⁱN₁N₂. In another example, N_{TRP}ⁱ CSI-RS resources on a cell have different numbers of CSI-RS ports, and codebook configurations specific to each resources. In this case, a number of CSI-RS ports associated with i-th sub-configuration is given by the sum of CSI-RS ports in N_{TRP}ⁱ CSI-RS resources on the cell.

Each CSI report sub-configuration can be further associated with one or multiple hypotheses of transmission powers for a signal or channel on a cell, e.g., ss-PBCH-BlockPower, powerControlOffsetSS, or powerControlOffset. In one example, a set of transmission power values is provided per CSI report sub-configuration for the cell and commonly applies to the CSI-RS resources associated with the sub-configuration. In another example, a set of transmission power values is provided per CSI-RS resource for each of the resources associated with the sub-configuration for the cell. The one or multiple power values can be provided in the CSI report configuration or CSI-RS resource configuration. In one example, one or multiple power values, such as ss-PBCH-BlockPower, powerControlOffsetSS, or powerControlOffset, are provided, and replace default values provided in ServingCellConfigCommon or NZP-CSI-RS-Resource IEs for the cell. In another example, one or multiple adjustment values, i.e., a set of ±Δ dB values, to a default power value are provided, and are added to the default value.

In 1320, the UE receives an indication from the serving gNB to provide CSI report for L CSI report sub-configurations from M CSI report sub-configurations for a cell. Triggering of CSI reporting can be via DCI in a PDCCH reception, or via MAC CE or RRC IE in a PDSCH reception. The signaling can be UE-specific (such as by DCI/transport block (TB) with CRC scrambled by C-RNTI or DCI/TB associated with a PDCCH reception in CCEs determined according to a UE-specific search space), UE-group-specific (such as by DCI/TB with CRC that is not scrambled by C-RNTI or DCI/TB associated with a PDCCH reception in CCEs determined according to a common search space), or cell-specific for example via a SIB. For example, a UE can monitor PDCCH for detecting a DCI format that triggers multiple CSI reports, which correspond to a number of CSI report sub-configurations provided in the CSI report configuration for a cell, according to a CSS set or a USS set. A list of CSI report sub-configuration indexes for reporting can be indicated in the DCI or by higher layer signaling, such as in a RRC IE or a MAC CE update, as a part of a ‘trigger state’ that is indicated by the DCI among a set of ‘trigger states’ that include the cell.

In 1330, the UE calculates CSI reports for L CSI report sub-configurations for the cell, wherein, for j-th sub-configuration, the CSI is calculated based on the associated N_{TRP}^{j} CSI-RS resources. In other words, the CSI quantities, such as CRI, CQI, PMI, RI, LI, RSRP, or SINR, are calculated based on N_{TRP}^{j} CSI-RS resources on the cell. For Type-II codebook, W₁ is calculated per TRP for N_{TRP}^{j} CSI-RS resources, W₂ is calculated across N_{TRP}^{j} CSI-RS resources. The frequency domain basis W_{f} is selected as TRP common for N_{TRP}^{j} CSI-RS resources on the cell. In addition, frequency domain relative offset Qᵢ for i-th TRP can be reported for N_{TRP}^{j} CSI-RS resources. For Type-I codebook, W₁ is calculated per TRP or TRP common, and W₂ is calculated across N_{TRP}^{j} CSI-RS resources on the cell. When a UE selects a subset of TRPs on the cell, the number of CSI-RS resources evaluated for CSI reporting by the UE is further reduced from N_{TRP}^{j}, and the UE reports indexes of chosen TRPs for the cell, e.g., using a bitmap of size N_{TRP}^{j}. In 1340, the UE provides CSI reports for L CSI report sub-configurations via a PUCCH or PUSCH transmission.

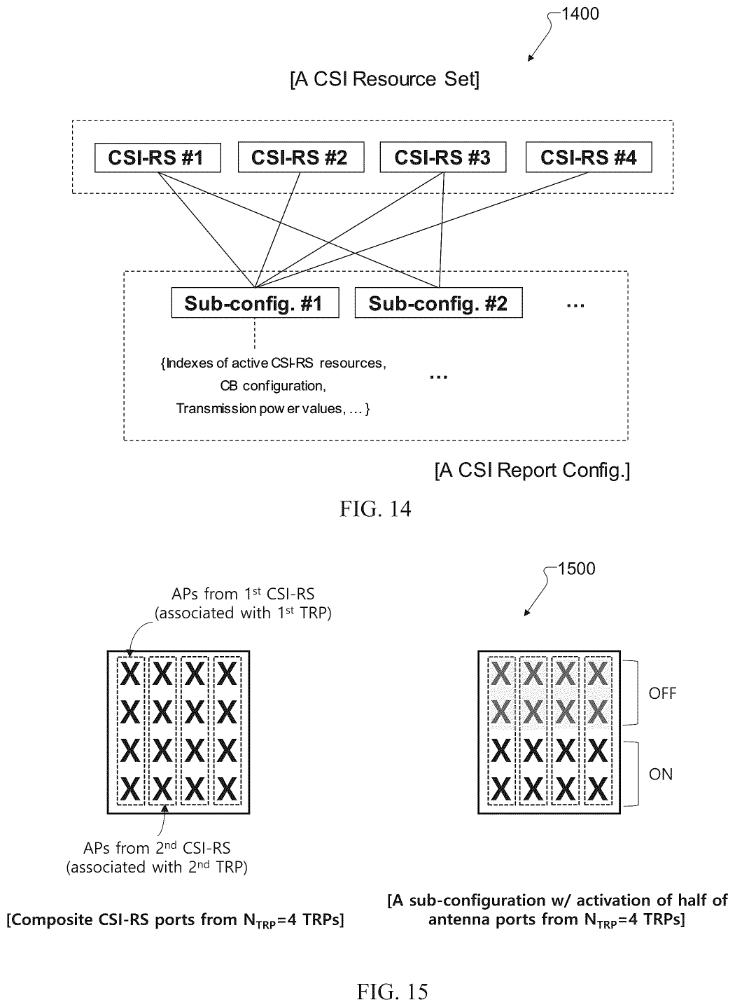

FIG. 14 illustrates a diagram of associations 1400 for CSI-RS resources with CSI report sub-configurations according to embodiments of the present disclosure. For example, associations 1400 for CSI-RS resources with CSI report sub-configurations may be referenced by any of the UEs 111-116 of FIG. 1, such as the UE 116 of FIG. 3. This example is for illustration only and other embodiments can be used without departing from the scope of the present disclosure.

A UE can be indicated, for example via RRC signaling, MAC CE or DCI, a number of hypotheses on Type-1 SD adaptations of TRPs on a cell. The UE (e.g., the UE 116) can provide a number of CSI reports according to the indicated hypotheses. A CSI report configuration provided to the UE can include a number of sub-configurations associated with operation states on the cell which correspond to different hypotheses of active set of antenna ports transmitted from mTRPs of the cell, which can be further associated with transmission or reception parameters in one or more of a power, spatial, time, or frequency domain, including TRP on/off, on the cell.

FIG. 15 illustrates a diagram of example CSI-RS antenna port mapping 1500 with Type-1 SD adaptation according to embodiments of the present disclosure. For example, CSI-RS antenna port mapping 1500 with Type-1 SD adaptation can be implemented by BS 102 of FIG. 2. This example is for illustration only and other embodiments can be used without departing from the scope of the present disclosure.

The left-hand side of FIG. 15 illustrates CSI-RS antenna port mapping for a full activation of Nₚₒᵣₜ=8 CSI-RS ports from N_{TRP}=4 CSI-RS resources on a cell as in FIG. 12. The right-hand side of FIG. 15 illustrates CSI-RS antenna port mapping for a hypothesis where only a half of the antenna ports, i.e., Nₚₒᵣₜ′=4, are active from N_{TRP}=4 CSI-RS resources on the cell. In this scenario, the CSI-RS port ordering can be done as follows: (CSI-RS resource #1, port #1), (CSI-RS resource #1, port #2), . . . , (CSI-RS resource index #1, port #4), . . . , (CSI-RS resource #4, port #1), (CSI-RS resource #4, port #2), . . . , (CSI-RS resource #4, port #4).

In FIG. 15, it is expected that N_{TRP} CSI-RS resources have same Nₚₒᵣₜ antenna ports and are configured to a common Type-1 SD adaptation hypothesis, i.e., an activation of a same subset of antenna ports, uniformly across mTRPs of a cell. In another example, a UE can be configured with N_{TRP} CSI-RS resources having the same Nₚₒᵣₜ antenna ports, but they are associated with different Type-1 SD adaptation hypotheses, i.e., different subsets or numbers of antenna ports among mTRPs of the cell. In another example, a UE can be configured with N_{TRP} CSI-RS resources on the cell having different numbers of antenna ports and they are further associated with different Type-1 SD adaptation hypotheses.

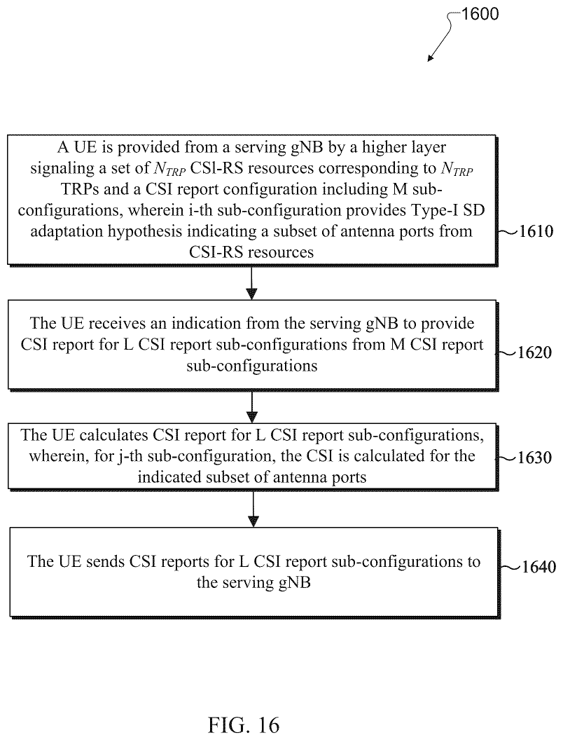

FIG. 16 illustrates a flowchart of an example UE procedure 1600 for reporting CSI for CJT from mTRP(s) with Type-1 SD adaptations. For example, procedure 1600 for reporting CSI for CJT from mTRP(s) with Type-1 SD adaptations may be performed by any of the UEs 111-116, such as the UE 111. This example is for illustration only and other embodiments can be used without departing from the scope of the present disclosure.

The procedure begins in 1610, a UE is provided from a serving gNB by a higher layer signaling a set of N_{TRP} CSI-RS resources corresponding to N_{TRP} TRPs and a CSI report configuration including M sub-configurations, wherein i-th sub-configuration provides Type-I SD adaptation hypothesis indicating a subset of antenna ports from CSI-RS resources. In 1620, the UE receives an indication from the serving gNB to provide CSI report for L CSI report sub-configurations from M CSI report sub-configurations. In 1630, the UE calculates CSI report for L CSI report sub-configurations, wherein, for j-th sub-configuration, the CSI is calculated for the indicated subset of antenna ports. In 1640, the UE sends CSI reports for L CSI report sub-configurations to the serving gNB.

In 1610, A UE is provided from a serving gNB by a higher layer signaling a set of N_{TRP} CSI-RS resources corresponding to N_{TRP} TRPs of a cell and a CSI report configuration including M sub-configurations, wherein i-th sub-configuration provides Type-1 SD adaptation hypothesis indicating a subset of antenna ports from N_{TRP} CSI-RS resources on the cell. The higher layer signaling can be an RRC IE. The set of N_{TRP} CSI-RS resources and the CSI report configuration including M sub-configurations may also be updated by a MAC CE or by DCI that indicates corresponding subsets of the ones provided in the RRC IE.

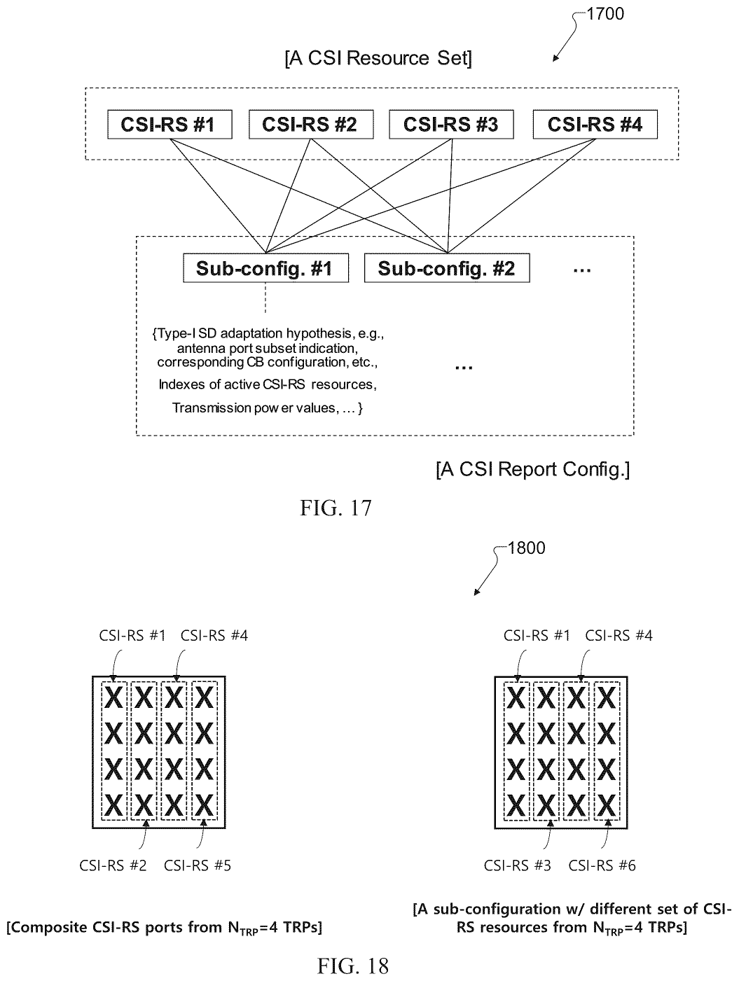

FIG. 17 illustrates a diagram of example associations 1700 for CSI-RS resources with CSI report sub-configurations according to embodiments of the present disclosure. For example, associations 1700 for CSI-RS resources with CSI report sub-configurations may be referenced by any of the UEs 111-116, such as the UE 111. This example is for illustration only and other embodiments can be used without departing from the scope of the present disclosure.

A CSI-RS resource in the resource set can be associated with more than one CSI report sub-configurations on a cell. If no TRP on/off adaptation is performed with Type-1 SD adaptation on the cell, CSI-RS resources can be associated with each and every CSI report sub-configuration. If TRP on/off adaptation is performed with Type-1 SD adaptation on the cell, a number of CSI-RS resources associated with a CSI report sub-configuration can be less than N_{TRP}. Each CSI report sub-configuration provides antenna port subset indication, which can be common for the associated CSI-RS resources or can be separately indicated. For a CSI-RS resource with nrofPorts, the antenna port subset can be indicated using a bitmap of size nrofPorts along with corresponding codebook configuration such as N₁-N₂, codebook subset restriction, rank restriction, and other parameters such as paramCombination, memberOfPMI-SubbandsPerCQI-Subband, memberOfBeams, phaseAlphabetSize, subbandAmplitude, and codebookMode. An antenna port subset can be also indicated by providing a list of code division multiplexing (CDM) group indexes and, additional, using a bitmap, whose size is equal to CDM group size, providing a list of active antenna ports within a CDM group. An antenna port subset can be also indicated by providing row-column indexes from the default codebook dimension N₁-N₂.

If the Type-1 SD adaptation is performed with TRP on/off or power domain adaptations on a cell, the CSI report sub-configuration can also provide indexes of active CSI-RS resources and a set of parameters related to transmission powers of signals or channels on the cell.

In 1620, the UE receives an indication from the serving gNB to provide CSI reports for L CSI report sub-configurations from M CSI report sub-configurations on the cell.

In 1630, the UE calculates CSI reports for L CSI report sub-configurations, wherein, for j-th sub-configuration, the CSI is calculated for the indicated subset of antenna ports on the cell. For example, if a first sub-configuration, corresponding to the full activation of antenna ports and TRPs on the cell, indicates 4×4 codebook for 4 TRPs, the UE calculates CSI for 4 of 32 CSI-RS ports, which is in total 128 ports. If a second sub-configuration, corresponding to a half activation of antenna ports from TRPs on the cell, indicates 4×2 codebook for 4 TRPs, the UE calculates CSI for 4 of 16 CSI-RS ports, which is in total 64 antenna ports. The CSI quantities, such as CRI, CQI, PMI, RI, LI, RSRP, or SINR, are calculated based on N_{TRP}^{j} CSI-RS resources on the cell expecting indicated antenna port subset and corresponding codebook configuration. The methods provided for 1330 can be similarly applied to 1630.

In 1640, the UE provides CSI reports for L CSI report sub-configurations for the cell, for example via a PUCCH or a PUSCH, to the serving gNB.

A UE can be indicated a number of hypotheses on Type-2 SD adaptations of TRPs on a cell and the UE can provide a number of CSI reports according to the indicated hypotheses. A CSI report configuration provided to the UE can include a number of sub-configurations associated with network operation states (operation states for the cell) which correspond to different hypotheses of active antenna elements constituting antenna ports from TRPs on the cell, which can be further associated with transmission or reception parameters in one or more of a power, spatial, time, or frequency domain, including TRP on/off and Type-1 SD adaptation on the cell.

FIG. 18 illustrates a diagram of example CSI-RS antenna port mapping 1800 with Type-2 SD adaptation according to embodiments of the present disclosure. For example, CSI-RS antenna port mapping 1800 with Type-2 SD adaptation can be implemented by BS 103 of FIG. 1. This example is for illustration only and other embodiments can be used without departing from the scope of the present disclosure.

A total number of antenna ports may remain same, if not combined with Type-1 SD adaptation or TRP on/off adaptation on a cell. Nonetheless, the set of CSI-RS resources comprising CSI-RS ports can be different. In one example, each or a subset of TRPs on the cell perform Type-2 SD adaptation. For instance, on the left-hand side of FIG. 18, CSI-RS resource IDs 1, 2, 4, 5 comprise the set of CSI-RS ports from mTRPs, while, on the right-hand side of FIG. 18, CSI-RS resource IDs 1, 3, 4, 6 comprise the set of CSI-RS ports from the mTRPs. This may correspond to a scenario in which only TRP #2 and TRP #4 perform Type-2 SD adaptation on the cell while antenna port configurations for TRP #1 and TRP #3 remain unchanged.

In FIG. 18, it is expected that N_{TRP} CSI-RS resources on a cell have the same Nₚₒᵣₜ antenna ports, while each of the CSI-RS resources can have different numbers of antenna ports.

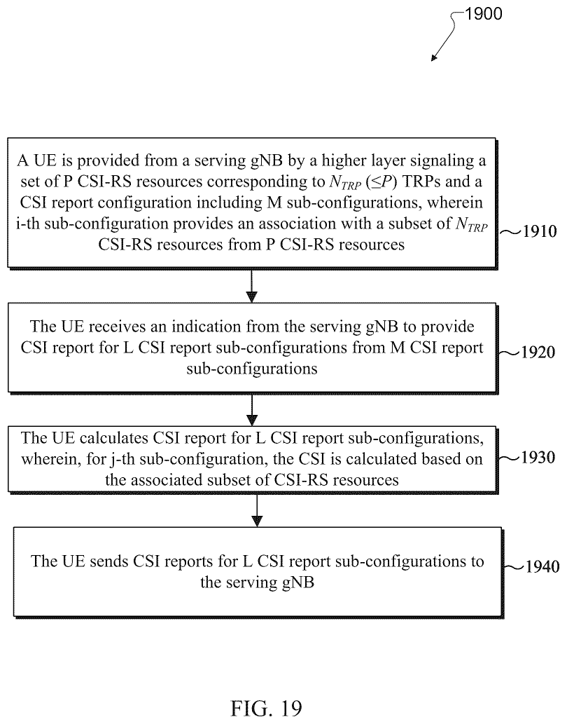

FIG. 19 illustrates a flowchart of an example UE procedure 1900 for reporting CSI for CJT from mTRP(s) with Type-2 SD adaptations according to embodiments of the present disclosure. For example, procedure 1900 for reporting CSI for CJT from mTRP(s) with Type-2 SD adaptations may be performed by any of the UEs 111-116 of FIG. 1, such as the UE 112. This example is for illustration only and other embodiments can be used without departing from the scope of the present disclosure.

The procedure begins in 1910, a UE is provided from a serving gNB by a higher layer signaling a set of P CSI-RS resources corresponding to N_{TRP} (≤P) TRPs and a CSI report configuration including M sub-configurations, wherein i-th sub-configuration provides an association with a subset of N_{TRP} CSI-RS resources from P CSI-RS resources. In 1920, the UE receives an indication from the serving gNB to provide CSI report for L CSI report sub-configurations from M CSI report sub-configurations. In 1930, the UE calculates CSI report for L CSI report sub-configurations, wherein, for j-th sub-configuration, the CSI is calculated based on the associated subset of CSI-RS resources. In 1940, the UE sends CSI reports for L CSI report sub-configurations to the serving gNB.

In 1910, a UE is provided from a serving gNB by a higher layer signaling a set of P CSI-RS resources corresponding to N_{TRP} (≤P) TRPs for a cell and an associated CSI report configuration including M sub-configurations, wherein i-th sub-configuration provides an association with a subset of N_{TRP} CSI-RS resources from P CSI-RS resources. The higher layer signaling can be an RRC IE. The set of P CSI-RS resources within a resource set and the CSI report configuration including M sub-configurations may also be updated by a MAC CE or by DCI that indicates corresponding subsets of the ones provided in the RRC IE.

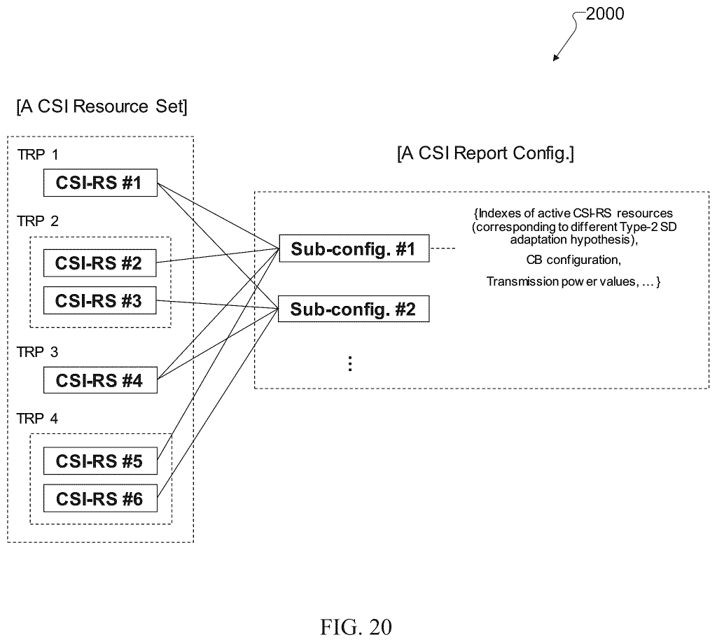

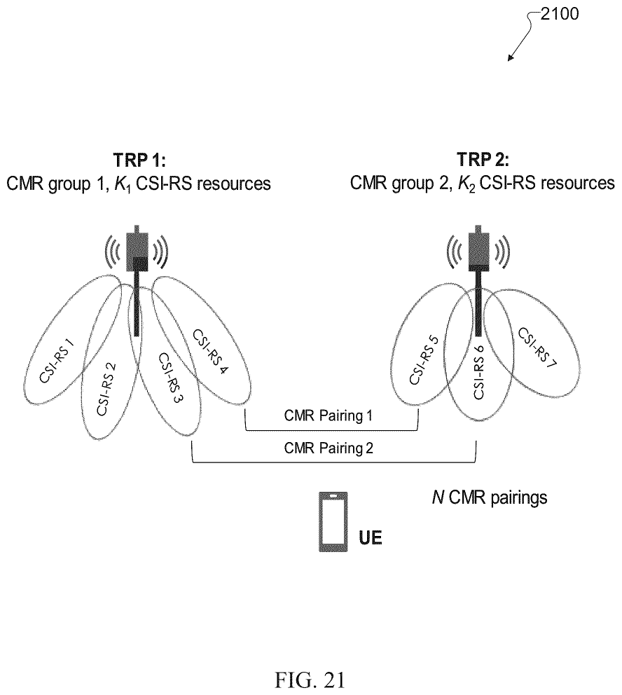

FIG. 20 illustrates a diagram of example associations 2000 for CSI-RS resources with CSI report sub-configurations according to embodiments of the present disclosure. For example, associations 2000 for CSI-RS resources with CSI report sub-configurations may be referenced by any of the UEs 111-116, such as the UE 112. This example is for illustration only and other embodiments can be used without departing from the scope of the present disclosure.

A UE is provided an association of N_{TRP} CSI-RS resources from the P CSI-RS resources with i-th CSI report sub-configuration on a cell, where the set of CSI-RS resources corresponds to a certain hypothesis of Type-2 SD adaptations of TRPs on the cell.

In FIG. 20, one or multiple CSI-RS resources may correspond to a TRP of a cell. One CSI-RS resource among the set of CSI-RS resources corresponding to a same TRP of the cell can be associated with a given CSI report sub-configuration. This restriction may be transparent to a UE and can be realized when N_{TRP} CSI-RS resources are indicated to the UE for a given CSI report sub-configuration on the cell. On the other hand, one CSI-RS resource can be associated with multiple CSI report sub-configurations such as when the corresponding TRP of the cell is not adapting among the sub-configurations. In FIG. 20, between CSI report sub-config. #1 and #2, it is expected that only TRP #2 and TRP #4 of the cell adapt CSI-RS transmission while TRP #1 and TRP #3 do not. When Type-2 SD adaptation of TRPs of the cell is combined with TRP on/off adaptation, the number of CSI-RS resources associated with a CSI report sub-configuration may be less than N_{TRP} CSI-RS resources.

In 1920, the UE receives an indication from the serving gNB to provide CSI reports for L CSI report sub-configurations from M CSI report sub-configurations on the cell.

In 1930, the UE calculates CSI reports for L CSI report sub-configurations, wherein, for j-th sub-configuration, the CSI report is calculated based on an associated subset of N_{TRP} CSI-RS resources on the cell. The methods provided for 1330 can be similarly applied to 1930.

In 1940, the UE provides CSI reports for L CSI report sub-configurations, for example via a PUCCH or a PUSCH, to the serving gNB.

CSI refers to any of CRI, RI, LI, PMI, CQI, RSRP, or SINR.

A serving gNB can configure Type-I and Type-II CSI codebooks to a UE using higher layer signalling to provide a CodebookConfig IE, as described in TS 38.331 v17.5.0, that includes the following parameters.
codebookType includes type1, type2 and sub-types such as type1-SinglePanel, type1-MultiPanel, typeII, and typeII-PortSelection, and corresponding parameters for each type.
n1-n2 configures a number of antenna ports in first (n1) and second (n2) dimension and codebook subset restriction for type1-SinglePanel.
ng-n1-n2 configures a number of antenna panels (ng), a number of antenna ports in first (n1) and second (n2) dimension expecting that the antenna structure is identical for the configured number of panels, and a codebook subset restriction for Type I Multi-panel codebook.
n1-n2-codebookSubsetRestriction configures a number of antenna ports in first (n1) and second (n2) dimension and a codebook subset restriction for typeII.
CodebookConfig-r17 includes type1-SinglePanel1-r17 and type1-SinglePanel2-r17 for type1 to enable configuration of different antenna structures for two TRPs.

The IE RS-ResourceMapping indicates a resource element mapping for a CSI-RS resource in the time and frequency domains. The container of the IE includes elements for configuration of time and resources such as by frequency domain firstOFDMSymbolIn Time Domain, firstOFDMSymbolIn Time Domain2, and frequencyDomainAllocation, the CSI-RS density by density, the number of ports by nrofPorts, and others. The IE CSI-RS-ResourceMapping comprises the NZP-CSI-RS-Resource and ZP-CSI-RS-Resource configurations that are included in the CSI-ResourceConfig. The IE CSI-ResourceConfig defines a group of one or more NZP-CSI-RS-ResourceSet, CSI-IM-ResourceSet and/or CSI-SSB-ResourceSet.

The IE CSI-ReportConfig is used to indicate to a UE parameters for providing a periodic or semi-persistent CSI report via PUCCH transmissions on the cell where CSI-ReportConfig is included, or to indicate parameters for providing a semi-persistent or aperiodic CSI report on a PUSCH as triggered by a DCI that the UE receives. The CSI-ReportConfig is set for certain CSI-ResourceConfigId for channel/interference measurements. The aforementioned CodebookConfig is also part of CSI-ReportConfig.

For aperiodic CSI report, both aperiodic CSI reporting and aperiodic CSI-RS transmission are triggered using a ‘CSI Request’ field within a DCI format scheduling a PUSCH transmission, such as DCI format 0_1. The ‘CSI Request’ field indicates a ‘Trigger State’ that points to a certain CSI-ReportConfigId and resourcesForChannel, e.g., NZP-CSI-RS-ResourceSet. The ‘CSI Request’ field can have up to 6 bits and can indicate up to 64 ‘Trigger States’. If a UE is configured with more than 64 ‘Trigger States’, a ‘Aperiodic CSI Trigger State Subselection’ MAC CE identifies a subset of Trigger States that are indicated by DCI. A CSI-Aperiodic TriggerState can include a number of CSI-AssociatedReportConfigInfo, which provides linked CSI-ReportConfigId and resourcesForChannel.

For semi-persistent CSI report on PUCCH, the semi-persistent CSI-RS resource is triggered by a “SP CSI-RS/CSI-IM Resource Set Activation/Deactivation” MAC CE that includes a SP CSI-RS resource set ID indicating an index of NZP-CSI-RS-ResourceSet containing Semi-Persistent NZP CSI-RS resources indicating the Semi-Persistent NZP CSI-RS resource set, which is to be activated or deactivated. Semi-persistent CSI reporting on PUCCH is triggered using the “SP CSI reporting on PUCCH Activation/Deactivation” MAC CE. The field Sᵢ in the MAC CE indicates the activation/deactivation status of the Semi-Persistent CSI report configuration within csi-ReportConfigToAddModList. So refers to the report configuration that includes PUCCH resources for semi-persistent CSI reporting in the indicated BWP and has the lowest CSI-ReportConfigId within the list with type set to semiPersistentOnPUCCH, Sᵢ refers to the report configuration that includes PUCCH resources for semi-persistent CSI reporting in the indicated BWP and has the second lowest CSI-ReportConfigId, and so on.

For semi-persistent CSI reporting on PUSCH, a CSI report is triggered using a ‘CSI Request’ field in a DCI format 0_1 with CRC scrambled by a SP-CSI-RNTI. The operating details are similar to those for an aperiodic CSI report.

For periodic CSI reporting, both reporting and periodic CSI-RS resources are configured and initiated by CSI-ReportConfig.

A UE is semi-statically configured by higher layers to perform periodic CSI reporting on the PUCCH. A UE can be configured by higher layers for multiple periodic CSI Reports corresponding to multiple higher layer configured CSI Reporting Settings, where the associated CSI Resource Settings are higher layer configured. Periodic CSI reporting on PUCCH formats 2, 3, 4 supports Type I CSI with wideband granularity.

A UE shall perform semi-persistent CSI reporting using PUCCH starting from the first slot that is after slot n+3Nₛₗₒₜ^{subframe,μ}, when the UE would transmit a PUCCH with HARQ-ACK slot information in slot n corresponding to the PDSCH carrying the activation command described in clause 6.1.3.16 of [6] where u is the SCS configuration for the PUCCH. The activation command will contain one or more Reporting Settings where the associated CSI Resource Settings are configured. Semi-persistent CSI reporting on the PUCCH supports Type I CSI. Semi-persistent CSI reporting using PUCCH format 2 supports Type I CSI with wideband frequency granularity. Semi-persistent CSI reporting using PUCCH formats 3 or 4 supports Type I CSI with wideband and sub-band frequency granularities and Type II CSI Part 1.

When a PUCCH provides a Type I CSI report with wideband frequency granularity, the CSI payload is independent of PUCCH format 2, 3, or 4 and is same irrespective of RI (if reported), CRI (if reported). A CSI-ReportConfig with codebookType set to ‘typeI-SinglePanel’ and a corresponding CSI-RS Resource Set for channel measurement configured with two Resource Groups and N Resource Pairs can be configured with wideband frequency granularity only with csi-ReportMode set to ‘Mode1’ and memberOfSingle TRP-CSI-Mode1 set to X=0. For type I CSI sub-band reporting on PUCCH formats 3, or 4, the payload is split into two parts. The first part contains RI (if reported), CRI (if reported), CQI for the first codeword. The second part contains PMI (if reported), LI (if reported) and contains the CQI for the second codeword (if reported) when RI>4. For a CSI-ReportConfig configured with subband reporting, codebookType set to ‘typeI-SinglePanel’ and the corresponding CSI-RS Resource Set for channel measurement configured with two Resource Groups and N Resource Pairs, Part 1 contains RI(s), CRI(s), CQI(s) for the first codeword and is zero padded to a fixed payload size (if needed). Part 2 contains the CQI(s) for the second codeword (if reported) when RI is larger than 4, LIs (if reported) and PMI(s).

A semi-persistent report provided using PUCCH formats 3 or 4 supports Type II CSI report, but only Part 1 of Type II CSI report (See Clauses 5.2.2 and 5.2.3 of TS 38.214 v17.6.0). Supporting Type II CSI reporting on the PUCCH formats 3 or 4 is a UE capability type2-SP-CSI-Feedback-LongPUCCH. A Type II CSI report (Part 1 only) carried on PUCCH formats 3 or 4 shall be calculated independently of any Type II CSI reports carried on the PUSCH (see Clause 5.2.3 of TS 38.214 v17.6.0).

When the UE (e.g., the UE 116) is configured with CSI Reporting on PUCCH formats 2, 3 or 4, each PUCCH resource is configured for each candidate UL BWP.

If the UE is in an active semi-persistent CSI reporting configuration on PUCCH and has not received a deactivation command, the CSI reporting takes place when the BWP in which the reporting is configured to take place is the active BWP. Otherwise, the CSI reporting is suspended.

A UE is not expected to report CSI with a total number of UCI bits and CRC bits larger than 115 bits when configured with PUCCH format 4. For CSI reports transmitted on a PUCCH, if CSI reports includes one part, the UE may omit a portion of CSI reports. Omission of CSI is according to the priority order determined from the Pri_{i,CSI} (y,k,c,s) value as defined in Clause 5.2.5 of TS 38.214 v17.6.0. CSI report is omitted beginning with the lowest priority level until the CSI report code rate is less or equal to the one configured by the higher layer parameter maxCodeRate.

If any of the CSI reports includes two parts, the UE may omit a portion of Part 2 CSI. Omission of Part 2 CSI is according to the priority order shown in Table 5.2.3-1 of TS 38.214 v17.6.0. Part 2 CSI is omitted beginning with the lowest priority level until the Part 2 CSI code rate is less or equal to the one configured by higher layer parameter maxCodeRate.

A UE shall perform aperiodic CSI reporting using PUSCH on serving cell c upon successful decoding of a DCI format, such as DCI format 0_1 or DCI format 0_2, which triggers an aperiodic CSI trigger state.

When a DCI format, such as DCI format 0_1, schedules two PUSCH allocations, the aperiodic CSI report is provided on the second scheduled PUSCH. When a DCI format schedules more than two PUSCH allocations, the aperiodic CSI report is carried on the penultimate scheduled PUSCH.

An aperiodic CSI report carried on the PUSCH supports wideband, and sub-band frequency granularities. An aperiodic CSI report carried on the PUSCH supports Type I, Type II, Enhanced Type II and Further Enhanced Type II Port Selection CSI.

A UE shall perform semi-persistent CSI reporting on a PUSCH upon successful decoding of a DCI format, such as DCI format 0_1 or DCI format 0_2, which activates a semi-persistent CSI trigger state. The DCI format contains a CSI request field which indicates the semi-persistent CSI trigger state to activate or deactivate. Semi-persistent CSI reporting on the PUSCH supports Type I, Type II with wideband, and sub-band frequency granularities, Enhanced Type II and Further Enhanced Type II Port Selection CSI. The PUSCH resources and MCS are allocated semi-persistently by the DCI format.

A CSI report can be multiplexed with data information on a PUSCH except that a semi-persistent CSI report on a PUSCH activated by a DCI format is not expected to be multiplexed with data information on the PUSCH.

Type I CSI report is supported for CSI Reporting on PUSCH. Type I wideband or sub-band CSI report is supported for CSI reporting on the PUSCH. Type II CSI report is supported for CSI reporting on the PUSCH.

For Type I, Type II, Enhanced Type II and Further Enhanced Type II Port Selection CSI report on PUSCH, a CSI report comprises of two parts. Part 1 has a fixed payload size and is used to identify the number of information bits in Part 2. Part 1 shall be transmitted in its entirety before Part 2.

For Type I CSI report, Part 1 contains RI (if reported), CRI (if reported), CQI for the first codeword (if reported). Part 2 contains PMI (if reported), LI (if reported) and contains the CQI for the second codeword (if reported) when RI is larger than 4. For a CSI-ReportConfig configured with codebookType set to ‘typeISinglePanel’ and the corresponding CSI-RS Resource Set for channel measurement configured with two Resource Groups and N Resource Pairs, Part 1 contains RI(s), CRI(s), CQI(s) for the first codeword and is zero padded to a fixed payload size (if needed). Part 2 contains the CQI(s) for the second codeword (if reported) when RI is larger than 4, LIs (if reported) and PMI(s).

For Type II CSI report, Part 1 contains RI (if reported), CQI, and an indication of the number of non-zero wideband amplitude coefficients per layer for the Type II CSI (see Clause 5.2.2.2.3 of TS 38.214 v17.6.0). The fields of Part 1-RI (if reported), CQI, and the indication of the number of non-zero wideband amplitude coefficients for each layer—are separately encoded. Part 2 contains the PMI and LI (if reported) of the Type II CSI. The elements of 11.4.1, 12.1.1 (if reported) and 12.2.1 (if reported) are reported in increasing order of their indices, i=0,1, . . . , 2L−1, where the element with the lowest index is mapped to the most significant bits and the element with the highest index is mapped to the least significant bits. Part 1 and 2 are separately encoded.

For Enhanced Type II CSI report (see Clause 5.2.2.2.5 of TS 38.214 v17.6.0) and Further Enhanced Type II Port Selection CSI report (see Clause 5.2.2.2.7 of TS 38.214 v17.6.0), Part 1 contains RI (if reported), CQI, and an indication of the overall number of non-zero amplitude coefficients across layers. The fields of Part 1-RI (if reported), CQI, and the indication of the overall number of non-zero amplitude coefficients across layers—are separately encoded. Part 2 contains the PMI of the Enhanced Type II or Further Enhanced Type II Port Selection CSI. Part 1 and 2 are separately encoded.

A Type II CSI report that is carried on the PUSCH shall be computed independently from any Type II CSI report that is provided using PUCCH formats 3 or 4 (see Clause 5.2.4 and 5.2.2 of TS 38.214 v17.6.0).

When reportQuantity is configured with one of the values ‘cri-RSRP’, ‘ssb-Index-RSRP’, ‘criSINR’ or ‘ssb-Index-SINR’, or ‘cri-RSRP-Capability [Set] Index’, ‘ssb-Index-RSRP-Capability [Set] Index’, ‘cri-SINRCapability [Set] Index’, ‘ssb-Index-SINR-Capability [Set] Index’, the CSI report includes a single part.

For both Type I and Type II reports configured for PUCCH but transmitted on PUSCH, the determination of the payload for CSI part 1 and CSI part 2 follows that of PUCCH as described in Clause 5.2.4 of TS 38.214 v17.6.0.

When a CSI report on PUSCH comprises two parts, the UE may omit a portion of the Part 2 CSI. Omission of Part 2 CSI is according to the priority order shown in Table 5.2.3-1 of TS 38.214 v17.6.0, where N_{Rep} is the number of CSI reports configured to be provided on the PUSCH. Priority 0 is the highest priority and priority 2N_{Rep} is the lowest priority and the CSI report n corresponds to the CSI report with the nth smallest Pri_{i,CSI} (y,k,c,s) value among the N_{Rep} CSI reports as defined in Clause 5.2.5 of TS 38.214 v17.6.0. The subbands for a given CSI report n indicated by csi-ReportingBand are numbered continuously in increasing order with the lowest subband of csi-ReportingBand as subband 0. When omitting Part 2 CSI information for a particular priority level, the UE shall omit the information at that priority level.

FIG. 21 illustrates an example system 2100 of a cooperative mTRP according to embodiments of the present disclosure. For example, the system 2100 may operate within the wireless network 100 in FIG. 1. This example is for illustration only and other embodiments can be used without departing from the scope of the present disclosure.

The number of antenna elements that can be integrated on a practically feasible antenna size can be restrictive at lower frequency bands due to the half-wavelength distancing between antenna elements to decorrelate the channel property. This motivates a distributed MIMO system, wherein multiple TRPs jointly transmit, either coherently or non-coherently, or receive channels or signals from a UE. In addition to supporting a larger number of antenna elements, the mTRP cooperative communication system can be beneficial in achieving spatial diversity gain or improving system reliability from a single point of failure. FIG. 21 illustrates non-coherent joint transmission (NC-JT) system by two TRPs and channel measurement resource (CMR) groups associated with the two TRPs. The CMR pairings of a pair of resources from the two CMR groups allows a UE to measure CSI for NC-JT by the two TRPs.

The following description is regarding UE procedures for reporting CSI for NC-JT by two TRPs.

If the UE is configured with a CSI-ReportConfig with the higher layer parameter reportQuantity set to ‘cri-RI-PMI-CQI’, or ‘cri-RI-LI-PMI-CQI’ and the corresponding NZP-CSI-RS-ResourceSet for channel measurement is configured with Kₛ≥2 resources, two Resource Groups with K₁≥1 resources in Group 1, K₂≥1 resources in Group 2, K₁+K₂=Kₛ, and N Resource Pairs:
Each resource can contain, subject to UE capability, at most 32 CSI-RS ports. For two Resource Groups with Kᵢ resources (i=1,2), if max {K₁, K₂}=1, the resource in NZP-CSI-RS-ResourceSet shall contain at most 32 CSI-RS ports; if max {K₁, K₂}=2, each resource in NZP-CSI-RS-ResourceSet shall contain at most 16 CSI-RS ports; if 2<max {K₁, K₂}<8, each resource in NZP-CSI-RS-ResourceSet shall contain at most 8 CSI-RS ports.
Each of the N Resource Pairs is associated to a CRI value.
The CSI-ReportConfig may be configured with higher layer parameter sharedCMR. M₁ and M₂ are the numbers of resources associated to a CRI value, other than the N CRIs defined herein, in Group 1 and Group 2, respectively, with M=M₁+M₂, such that the total number of CRI values configured for the CSI-ReportConfig is M+N.
If the higher layer parameter csi-ReportMode is set to ‘Mode1’ and the higher layer parameter memberOfSingleTRP-CSI-Mode1 is set to X∈{0}, M₁=M₂=0; otherwise,
if the higher layer parameter csi-ReportMode is set to ‘Mode1’ and the higher layer parameter memberOfSingle TRP-CSI-Mode1 is set to X∈{1,2}, or if csi-ReportMode is set to ‘Mode2’:
   if sharedCMR is configured: M₁=K₁ and M₂=K₂; otherwise
   if sharedCMR is not configured, the resources in Group 1 and Group 2 that are not referred to in any Resource Pair are associated to M CRI values other than the N CRIs defined herein.
If interference measurement is performed on CSI-IM, M+N resources are configured in the corresponding csi-IM-ResourceSet. The M resources for channel measurement defined herein are resource-wise associated with the first M CSI-IM resources by the ordering of the CSI-RS resources and CSI-IM resources in the corresponding Resource Set. The N Resource Pairs for channel measurement are associated to the last N CSI-IM resources by the ordering of the CSI-RS Resource Pairs and CSI-IM resources in the CSI-IM Resource Set. The UE may expect that the two CSI-RS resources for channel measurement in a Resource Pair and the associated CSI-IM resource for interference measurement are resource-wise QCLed with respect to ‘typeD’.
The UE is not expected to be configured with NZP CSI-RS for interference measurement other than the NZP CSI-RS resources for channel measurement configured in the N Resource Pairs.
The UE expects, for that CSI-ReportConfig, to be configured with higher layer parameter codebookType set to ‘type1-SinglePanel’,
The UE shall derive the CSI parameters other than CRI(s) conditioned on the reported CRI(s), as follows:
   If the higher layer parameter csi-ReportMode is set to ‘Mode1’ and the higher layer parameter memberOfSingle TRP-CSI-Mode1 is set to X∈{0,1,2}, X+1 CRI(s) are reported:
      One CRI k₁ (k₁≥0) corresponds to the configured (k₁+1)-th entry of the associated N Resource Pairs in the corresponding CSI-RS Resource Set for channel measurement, and (M+k₁+1)-th entry of the corresponding CSI-IM Resource Set, if configured. The UE shall report two RIs, two PMIs, two LIs (if configured), associated to the resource in Group 1 and the resource in Group 2, respectively, of the (k₁+1)-th Resource Pair, and one CQI; and
      If X=1, one CRI k₂ (k₂≥0) corresponds to the configured (k₂+1)-th entry of the associated M resources in the corresponding CSI-RS Resource Set for channel measurement and (k₂+1)-th entry of the corresponding CSI-IM Resource Set, if configured. The UE shall report one RI, one PMI, one LI (if configured) and one or two CQIs conditioned on CRI k₂; or
      If X=2, one CRI k₂ (k₂≥0) corresponds to the configured (k₂+1)-th entry of the associated M₁ resources in Group 1 of the corresponding CSI-RS Resource Set for channel measurement, and (k₂+1)-th entry of the associated resources in the corresponding CSI-IM Resource Set, if configured, and one CRI k₃ (k₃≥0) corresponds to the configured (k₃+1)-th entry of the associated M₂ resources in Group 2 of the corresponding CSI-RS Resource Set for channel measurement, and (M₁+k₃+1)-th entry of the corresponding CSI-IM Resource Set, if configured. The UE shall report one RI, one PMI, one LI (if configured) and one or two CQIs conditioned on CRI k₂ and one RI, one PMI, one LI (if configured) and one or two CQIs conditioned on CRI k₃.
   If the higher layer parameter csi-ReportMode is set to ‘Mode2’, one CRI k₁ (k₁≥0) is reported which corresponds to the (k₁+1)-th entry of the M+N resources or Resource Pairs in the corresponding CSI-RS Resource Set for channel measurement and (k₁+1)-th entry of the associated resources in the corresponding CSI-IM Resource Set, if configured. The first M codepoints of the CRI correspond to resources associated to Group 1 and Group 2. The last N codepoints of the CRI correspond to the N configured Resource Pairs. The UE shall report one RI, one PMI, one LI, if configured, and one or two CQIs conditioned on CRI k₁ if k₁<M; or two RIs, two PMIs, two LIs, if configured, associated to the resource in Group 1 and the resource in Group 2, respectively, of the (k₁-M+1)-th Resource Pair, and one CQI, otherwise.
For a reported CRI corresponding to an entry of the N Resource Pairs configured in the corresponding CSI-RS Resource Set for channel measurement:
   The UE shall not report a total number of layers larger than four.
   The two RIs are reported with a joint RI index corresponding to one of the four rank combinations: {1,1}, {1,2}, {2,1}, {2,2}.
The CodebookConfig in CSI-ReportConfig can be configured with two RI restriction parameters. One parameter applies to a reported RI when conditioned on a CRI corresponding to an entry of the M CSI-RS resources defined herein. Another parameter applies to a reported joint RI index when conditioned on a CRI corresponding to an entry of the N Resource Pairs and indicates one or more of the four rank combinations that are allowed to correspond to the reported PMIs and RIs.
The CodebookConfig in CSI-ReportConfig can be configured with two Codebook Subset Restrictions. The first restriction applies to a reported PMI associated to a CSI-RS resource in Group 1. The second restriction applies to a reported PMI associated to a CSI-RS resource in Group 2.

Present networks have limited capability to adapt an operation state in one or more of time/frequency/spatial/power domains. For example, in NR, there are transmissions or receptions on a cell by a serving gNB that are expected by UEs, such as transmissions of synchronization signals/physical broadcast channel (SS/PBCH) blocks, or of system information, or of CSI-RS indicated by higher layers, or receptions of physical random access channel (PRACH) or sounding reference signal (SRS) indicated by higher layers. Reconfiguration of a NW operation state involves higher layer signaling by a system information block (SIB) or by UE-specific RRC. That is a slow process and requires substantial signaling overhead, particularly for UE-specific RRC signaling. For example, it is currently not practical or possible for a network in typical deployments to enter an energy saving operation state where the network (e.g., the network 130) does not transmit or receive due to low traffic on a cell as, in order to obtain material energy savings, the network needs to suspend transmissions or receptions for several tens of milliseconds and preferably for even longer time periods. A similar inability exists for suspending transmission or receptions on a cell for shorter time periods as a serving gNB may need to frequently transmit SS/PBCH blocks on the cell, such as every 5 msec or every 20 msec and, in time division duplex (TDD) systems with UL-DL configurations having few UL symbols in a period, the serving gNB may need to receive PRACH or SRS on the cell in most UL symbols in a period.

Due to the reasons herein, adaptation of a NW operation state on a cell is typically over long time periods, such as for off-peak hours when an amount of served traffic is small and for peak hours when an amount of served traffic is large. Therefore, a capability of a gNB to improve service by fast adaptation of a NW operation state to the traffic types and load on a cell, or to save energy by switching to an operation state that requires less energy consumption when an impact on service quality would be limited or none on a cell, is currently limited as there are no procedures for a serving gNB to perform fast adaptation of a NW operation state with small signaling overhead while simultaneously informing UEs of the NW operation state for a cell.

It is also beneficial to support a gradual transition of NW operation states on a cell between a maximum state where the cell operates at its maximum capability in one or more of a time/frequency/spatial/power domain and a minimum state where the cell operates at its minimum capability, or the cell enters a sleep mode. That would allow continuation of service while the cell transitions from a state with larger utilization of time/frequency/spatial/power resources to a state with lower utilization of such resources and the reverse as UEs can obtain time/frequency synchronization and automatic gain control (AGC) alignments, perform measurements and provide CSI reports or transmit SRS prior to scheduling of PDSCH receptions or PUSCH transmissions.

In order to enable a gNB to operate a cell on sleep state and save energy while minimizing an impact on served UEs on the cell, the gNB (e.g., the gNB 102) can apply discontinued transmissions (cell DTX) or discontinued receptions (cell DRX) on the cell. A UE can be informed of corresponding cell DTX/DRX configurations for a cell such that the UE can operate accordingly and avoid power consumption when the cell is in a dormant state (cell DTX/DRX). By turning off each or a part of a transmission chain and pausing transmission during the cell DTX, the gNB can reduce energy consumption for standby when there is little to no traffic on a cell. For cell DTX, a UE may expect that transmissions from a serving gNB on the cell are suspended or the UE may expect that some signals, such as primary synchronization signal (PSS) or secondary synchronization signal (SSS) for maintaining synchronization, remain present during cell DTX. By turning off each or a part of receiver chain and pausing receptions during the cell DRX, the gNB can reduce energy consumption for standby on a cell when there is little to no traffic on the cell. For cell DRX, a UE may expect that transmissions from the UE on a cell are suspended or may expect that some transmissions, such as ones required for initial access such as PRACH, are allowed during a cell DRX duration.

With reference to FIGS. 9A and 9B, cell DTX/DRX can be configured via at least a periodicity, a start slot/offset, and an on-duration. A UE expects that transmissions/receptions by the gNB on a cell are enabled during the DTX/DRX on-duration, respectively. The configurations and operations of cell DTX and cell DRX can be linked or can be separate, for example depending on DL/UL traffic characteristics on the cell.

The energy consumption by power amplifiers (PA) for each set of antenna elements (AEs) accounts for a large portion of total energy consumption by a gNB equipped with massive MIMO antennas. For network energy savings, when the traffic load is low, the gNB can turn off a subset of PAs or reduce the PA output power levels on one or more cells. For brevity, such operation is respectively referred to as spatial domain (SD) or power domain (PD) adaptation in this disclosure. Unlike cell DTX/DRX illustrated in FIG. 9, one advantage of SD/PD adaptation is that the network can maintain continuity of transmissions and receptions on a cell without interruptions by operating at a reduced capability.

A gNB can enable/disable AEs associated to a logical antenna port or enable/disable a subset of AEs associated to a logical antenna port for transmissions on a cell. For brevity, those adaptations of AEs are respectively referred to as Type 1 and Type 2 SD adaptations in this disclosure. The gNB may perform Type 1 SD adaptation, or Type 2 SD adaptation, or both.

In a hybrid beamforming system as illustrated in FIG. 5, one antenna port is connected to a large number of AEs that can be controlled by a bank of analog phase shifters, which is referred to as TxRU virtualization. The TxRU virtualization can be implemented based on sub-array partition model, full-connection model, or combinations of them, as illustrated in FIG. 10. In a sub-array partition model, spatial element adaptations can result in both Type 1 and Type 2 SD adaptations. In case of Type 1 SD adaptation, both the PAs connected to AEs associated to a logical antenna port and the subsequent RF chain, e.g., ADC/DAC, etc., associated to the logical antenna port can be turned off. In a full-connection model, spatial element adaptations can only result in Type 2 SD adaptations unless the antenna ports are turned off.

The impact of Type 1 SD adaptation results in a change in a number of active antenna ports or antenna structure in general. The RF characteristics, e.g., radiation power, beam pattern, etc., of remaining antenna ports remain same. The impact of Type 2 SD adaptation results in a change in the RF characteristics of antenna ports affected by AE on/off while the number of antenna ports remains the same. The impact of PD adaptation is similar to Type 2 SD adaptation. A gNB can perform any combination of Type 1 SD, Type 2 SD, and PD adaptations on a cell, together with other time/frequency domain adaptation techniques such as cell DTX/DRX.

Network operation parameters for transmission or reception on a cell can be in one or more of a power, spatial, time, or frequency domain.

For example, in power domain, a first NW operation state for a cell can be associated with a first value of parameter ss-PBCH-BlockPower providing an average energy per resource element (EPRE) with secondary synchronization signals (SSS) in dBm, and a second NW operation state can be associated with a second value of a parameter ss-PBCH-BlockPower. For example, first and second NW operation states for a cell can be respectively associated with first and second values of parameter powerControlOffsetSS that provides a power offset (in dB) of non-zero power (NZP) CSI-RS RE to SSS RE. For example, first and second NW operation states for a cell can be respectively associated with first and second values of parameter powerControlOffset that provides a power offset (in dB) of PDSCH RE to NZP CSI-RS RE.

For example, in frequency domain, first and second NW operation states for a cell can be respectively associated with first and second values of a parameter locationAndBandwidth that indicates a frequency domain location and a bandwidth for receptions or transmissions by a UE on the cell. For example, first and second NW operation states for a cell can be respectively associated with first and second values of a parameter BWP-Id for an active DL BWP or an active UL on the cell. For example, first and second NW operation states can be respectively associated with first and second values of a list of cells for active transmission and reception. The cells can be serving cells or non-serving cells for example in case of mobility.

For example, in spatial domain, first and second NW operation states for a cell can be respectively associated with first and second values of a parameter maxMIMO-Layers that indicates a maximum number of MIMO layers to be used for PDSCH receptions by a UE in the associated active DL BWP of the cell, or with first and second values of a parameter nrOfAntennaPorts that indicates a number of antenna ports to be used for codebook determination for PDSCH receptions on the cell, or with first and second values of a parameter activeCoresetPoolIndex for coresetPoolIndex values for PDCCH reception in corresponding CORESETs on the cell and the UE can skip PDCCH receptions in a CORESET with a coresetPoolIndex value that is not indicated by activeCoresetPoolIndex. For example, first and second NW operation states for a cell can be respectively associated with first and second values of an antenna port subset that indicates a list of active antenna ports for CSI calculation and other associated parameters such as codebook subset restriction, rank restriction, the logical antenna size in two-dimension, number of antenna ports, a list of CSI-RS resources, etc., for the cell.

For example, in time domain, first and second NW operation states for a cell can be respectively associated with first and second values of a parameter ssb-PeriodicityServingCell that indicates a transmission periodicity in milliseconds for SS/PBCH blocks on the cell, or with first and second values of a parameter ssb-PositionsInBurst that indicates time domain positions of SS/PBCH blocks in a SS/PBCH block transmission burst on the cell, or with first and second values of a parameter groupPresence that indicates groups of SS/PBCH blocks, such as groups of four SS/PBCH blocks with consecutive indexes, that are transmitted on the cell. For example, first and second NW operation states for a cell can be respectively associated with first and second values of a time pattern, e.g., in terms of periodicity, on-duration, start offset, etc., that indicates cell discontinuous transmission (DTX) or cell discontinuous reception (DRX) for the cell.

A network may need to assess an impact of adapting network transmission or reception parameters on a cell in one or more of a power, spatial, time, or frequency domain, such as turning on or off a subset of TRPs from a set of TRPs for the cell, prior to executing an actual adaptation by providing multiple CSI report sub-configurations for the cell, which correspond to different hypotheses of an active set of TRPs on the cell, to a UE and receiving multiple CSI reports from the UE. To provide multiple CSI report sub-configurations, which correspond to different set of active TRPs for a cell, there is a need for defining procedures and methods to associate a subset of CMR groups from the set of CMR groups defined in a CSI-RS resource set with a report sub-configuration to obtain CSI for NC-JT from the corresponding set of active TRPs for the cell. There is another need for defining procedures and methods for deriving CSI report quantities for NC-JT when the set of active TRPs on the cell changes.

A number of CSI report sub-configurations may also correspond to different Type-1 SD adaptation hypotheses with different number of active antenna ports from TRPs of a cell. Thus, the CSI report sub-configurations can be further associated with a subset of antenna ports from the set of antenna ports configured and transmitted for a CMR group of resources in a resource set. To provide CSI report sub-configurations corresponding to different Type-1 SD adaptation hypotheses, there is a need for defining procedures and methods to indicate a subset of antenna ports for one or more TRPs of the cell. Also, there is another need for defining procedures and methods for deriving CSI report quantities for NC-JT when the number of CSI-RS antenna ports changes from one or more TRPs on the cell.

A number of CSI report sub-configurations may also correspond to different Type-2 SD adaptation hypotheses with a different set of spatial elements comprising each antenna port for CSI-RS transmission from one or more TRPs of a cell. To provide CSI report sub-configurations corresponding to different Type-2 SD adaptation hypotheses, there is a need for defining procedures and methods to associate a different set of CMR groups or, in general, a subset of CSI-RS resources from the resource set to assess the impact on NC-JT with different antenna configurations at one or more TRPs of the cell.

The disclosure relates to a communication system.

The disclosure relates to defining functionalities and procedures for reporting CSI for NC-JT from mTRPs of a cell that is associated with multiple network operating states for the cell (adaptation hypotheses or cell operation states) in one or more of a power, spatial, time, or frequency domain, for example in order to support network energy savings for the cell.

The disclosure further relates to obtaining CSI for NC-JT from mTRPs of a cell corresponding to a hypothesis of TRP on/off adaptations on the cell.

The disclosure also relates to obtaining CSI for NC-JT from mTRPs of a cell corresponding to a hypothesis of Type-1 SD adaptations of TRPs of the cell.

The disclosure is further related to obtaining CSI for NC-JT from mTRPs of a cell corresponding to a hypothesis of Type-2 SD adaptations of TRPs of the cell.

A description of example embodiments is provided on the following pages.

Embodiments of the disclosure for reporting CSI for NC-JT from mTRPs of a cell associated with multiple network operating states (adaptation hypotheses or cell operation states) in one or more of a power, spatial, time, or frequency domain, for example in order to support network energy savings for the cell, are summarized in the following and are fully elaborated further herein.
Method and apparatus for obtaining CSI for NC-JT from mTRPs of a cell corresponding to a hypothesis of TRP on/off adaptations on the cell.
Method and apparatus for obtaining CSI for NC-JT from mTRPs of a cell corresponding to a hypothesis of Type-1 SD adaptations of TRPs on the cell.
Method and apparatus for obtaining CSI for NC-JT from mTRPs of a cell corresponding to a hypothesis of Type-2 SD adaptations of TRPs on the cell.

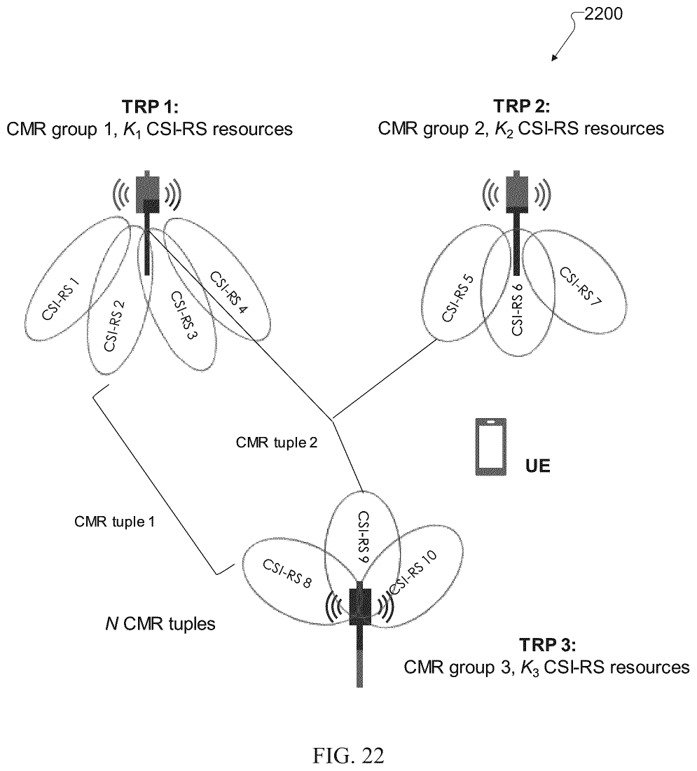

FIG. 22 illustrates an example system 2200 of CSI-RS resource configuration for NC-JT according to embodiments of the present disclosure. For example, system 2200 may operate within the wireless network 100 in FIG. 1. This example is for illustration only and other embodiments can be used without departing from the scope of the present disclosure.

The number of TRPs of a cell can be generalized to N_{TRP} TRPs. While some examples are provided for two or three TRPs, the embodiments provided in this disclosure can be generally understood for N_{TRP} TRP scenarios.

To measure and report CSI for NC-JT from mTRPs, a UE can be provided a CSI-RS resource set including N_{TRP} CMR groups, wherein each CMR group corresponds to a certain TRP, and a number of CMR tuples includes two or more CSI-RS resources, wherein each CSI-RS resource comprising the tuple is from a different CMR group. When N_{TRP}=2, a CMR tuple is referred to as a CMR pair. The UE (e.g., the UE 116) then calculates CSI for a reception from a single TRP from a set of TRPs of a cell, or for NC-JT by two or more TRPs from the set of TRPs of the cell, according to the indication from the serving gNB. A number of antenna ports may be same across CSI-RS resources within a CMR group but may not necessarily be same across different CMR groups. Therefore, the UE can be provided separate CSI report configurations, such as codebook configuration, for different CMR groups in the CSI-RS resource set.

A gNB may decide to turn off a subset of TRPs from a set of TRPs on a cell, for example, for network energy saving. Accordingly, a UE can be indicated by a serving gNB a number of hypotheses on activation/deactivation of TRPs from a set of TRPs on a cell and the UE can provide a number of CSI reports according to the indicated hypotheses that correspond to a different set of active TRPs on the cell. A CSI report configuration provided to the UE can include a number of sub-configurations associated with network operation states (or cell operation states) which correspond to different hypotheses of mTRP on/off adaptations on the cell. Each CSI report sub-configuration can be further associated with a hypothesis on the parameters for transmission or reception in one or more of a power, spatial, time, or frequency domain on the cell, where the parameters may be indicated and applied per-TRP or commonly across mTRPs of the cell.

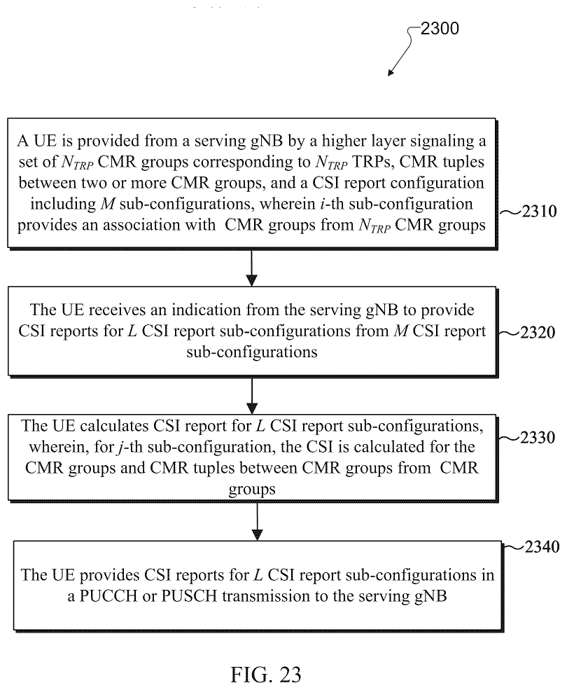

FIG. 23 illustrates a flowchart of an example UE procedure 2300 for reporting CSI for NC-JT from mTRPs with on/off adaptations according to embodiments of the present disclosure. For example, procedure 2300 for reporting CSI for NC-JT from mTRPs with on/off adaptations may be performed by any of the UEs 111-116 of FIG. 1, such as the UE 113. This example is for illustration only and other embodiments can be used without departing from the scope of the present disclosure.

In 2310, a UE is provided from a serving gNB by a higher layer signaling a set of N_{TRP} CMR groups corresponding to N_{TRP} TRPs, CMR tuples between two or more CMR groups, and a CSI report configuration including M sub-configurations, wherein i-th sub-configuration provides an association with N_{TRP}ⁱ CMR groups from N_{TRP} CMR groups. The UE is provided N_{TRP} CMR groups from the N_{TRP} CMR groups such as, for example, by a list of CMR group indexes or using a bitmap of size N_{TRP}, where the indicated one or more CMR groups correspond to a set of active TRPs from N_{TRP} TRPs of the cell. The higher layer signaling can be an RRC IE. The CSI-RS resource sets and the CSI report configuration including M sub-configurations may also be updated by a MAC CE that indicates corresponding subsets of the ones provided in the RRC IE.

In addition to indicating a set of active TRPs via CMR group indexes, the higher layer signaling can also provide adaptable parameters for transmission or reception by the active TRPs in one or more of a power, spatial, time, or frequency domain on the cell. For instance, each CSI report sub-configuration is further associated with one or multiple hypotheses of transmission powers for a signal or channel on a cell, e.g., ss-PBCH-BlockPower, powerControlOffsetSS, or powerControlOffset. In one example, for a given sub-configuration, a set of transmission power values is provided per CMR group within a CSI-RS resource set and commonly applies to the CSI-RS resources associated with the CMR group. In another example, a set of transmission power values is provided per CSI-RS resource for a given CMR group. The one or multiple power values can be provided in the CSI report configuration or in the CSI-RS resource configuration. In one example, one or multiple power values, such as ss-PBCH-BlockPower, powerControlOffsetSS, or powerControlOffset, are provided, and replace default values provided in ServingCellConfigCommon or NZP-CSI-RS-Resource IEs for the cell. In another example, one or multiple adjustment values, i.e., a set of #A dB values, to a default power value are provided, and are added to the default value.

In 2320, the UE receives an indication from the serving gNB to provide CSI reports for L CSI report sub-configurations from M CSI report sub-configurations. Triggering of CSI reporting can be via DCI in a PDCCH reception, or via MAC CE or RRC IE in a PDSCH reception. The signaling can be UE-specific (such as by DCI/TB with CRC scrambled by C-RNTI or DCI/TB associated with a PDCCH reception in CCEs determined according to a UE-specific search space), UE-group-specific (such as by DCI/TB with CRC that is not scrambled by C-RNTI or DCI/TB associated with a PDCCH reception in CCEs determined according to a common search space), or cell-specific for example via a SIB. For example, a UE can monitor PDCCH for detecting a DCI format that triggers multiple CSI reports, which correspond to a number of CSI report sub-configurations provided in the CSI report configuration for a cell, according to a CSS set or a USS set. A list of CSI report sub-configuration indexes for reporting can be indicated in the DCI or by higher layer signaling, such as in a RRC IE or a MAC CE update, as a part of a ‘trigger state’ that is indicated by the DCI among a set of ‘trigger states’ that include the cell.

In another example, the DCI or higher layer signaling, such as MAC CE or RRC, can also provide an update on the current operation state on the cell such as by indicating an index from the M CSI report sub-configurations, by providing a list of active CMR group indexes, or by indicating parameters for transmission or reception by one or more TRPs in one or more of a power, spatial, time, or frequency domain on the cell. Upon receiving an update on the current operation state on the cell, the UE adapts its CSI reporting or PDCCH monitoring behavior accordingly.

Using the example in FIG. 21, a UE can be indicated that TRP 1 and TRP 3 are active while TRP 2 is inactive, such as by providing a list of corresponding CMR group indexes, i.e., {1, 3}, or using a bitmap, i.e., 101, where the value 1 in i-th bit-position indicates that the i-th CMR group is active. Upon receiving such an indication, in one example, the UE starts reporting CSI involving only TRP 1 and TRP 3 for the corresponding CSI report configuration. That is, if csi-ReportMode is set to mode 1 for NC-JT CSI reporting, a CSI report from the UE may include a CRI from CMR group 1 and 3 with corresponding CSI report quantities if memberOfSingle TRP-CSI-Mode1 is set to 1, or a CRI from CMR group 1 with corresponding CSI report quantities and another CRI from CMR group 3 and the corresponding CSI report quantities if memberOfSingle TRP-CSI-Mode1 is set to 2, and the CSI report does not include CRI from CMR group 2. The CSI report can also include CRI from the set of valid CMR tuples for NC-JT CSI. In one example, a valid CMR tuple is defined as a tuple consisting of CSI-RS resources only from the active CMR groups. With this definition, only CMR tuple 1 is valid in FIG. 21. In another example, a valid CMR tuple is defined as a tuple including CSI-RS resources from at least two active CMR groups while the CSI is calculated and reported expecting CSI-RS resources only from the active CMR groups comprising the CMR tuple. With this definition, both CMR tuple 1 and 2 are valid in FIG. 21. However, CSI for CMR tuple 2 is calculated and reported only for {CSI-RS 3, CSI-RS 9} excluding CSI-RS 5 from TRP 2. If csi-ReportMode is set to mode 2, the UE may select a CRI from {CSI-RS 1, CSI-RS 2, CSI-RS 3, CSI-RS 4, CSI-RS 8, CSI-RS 9, CSI-RS 10, CMR tuple 1, CMR tuple 2} and provide CSI report quantities corresponding to the chosen CRI. Depending on the example definition of a valid CMR tuple described herein, CMR tuple 2 may or may not be included in the set for CRI selection. If included for CRI selection, the CMR tuple 2 includes CSI-RS resources from active CMR groups only. If a UE is indicated that only one TRP is active, the CSI report configuration degenerates to a common CSI reporting for single TRP and the UE shall ignore configured CMR tuples for NC-JT CSI.

In another example, upon receiving an update on the current operation state on the cell via DCI or higher layer signaling, the UE adapts its PDCCH monitoring behavior accordingly. For instance, a UE can be indicated a list of coresetPoolIndexes from the set of coresetPoolIndexes associated with N_{TRP} TRPs and, upon receiving such an indication, the UE starts monitoring PDCCH only for the indicated coresetPoolIndexes. Alternatively, there may be an implicit association between coresetPoolIndexes and CMR groups, e.g., two IEs having the same index value, or the UE may be provided an explicit association between coresetPoolIndexes and CMR groups via higher layer signaling. Upon receiving an indication on a set of active CMR groups, the UE can also identify associated coresetPoolIndexes and start monitoring PDCCH only for the identified active coresetPoolIndexes.

In 2330, the UE calculates CSI report for L CSI report sub-configurations, wherein, for j-th sub-configuration, the CSI is calculated for the N_{TRP}^{j} CMR groups and CMR tuples between CMR groups from N_{TRP}^{j} CMR groups. The UE behavior for reporting CSI described for 2320 upon receiving an update on the current operation state on the cell can apply to 2330. For CSI reporting corresponding to a single active TRP, CSI report quantities such as CRI, RI, PMI, CQI, and LI are reported per TRP. For CSI reporting corresponding to NC-JT from two or more active TRPs, single CRI for the corresponding CMR tuple and a single CQI value are reported, while RI, PMI, and LI are individually reported for the active TRPs.

If the UE is provided more than one transmission power values such as ss-PBCH-BlockPower, powerControlOffsetSS, or powerControlOffset, the CSI can be reported for multiple power values. For instance, if a CRI is chosen from a certain CMR group for a single TRP transmission, the CSI report quantities can be reported expecting multiple different power values. If a CRI is chosen from a certain CMR tuple for NC-JT transmission, the CSI report quantities can be reported expecting different power values for each constituent CSI-RS resources from more than one CMR groups. In one example, one or more sets of power offset values corresponding to a set of CSI-RS resources comprising the CMR tuple, i.e., to a set of active TRPs of a cell, can be provided to the UE by higher layers. In another example, CSI report quantities are calculated expecting a common set of power adjustment values, i.e., +A dB, to the respective power values configured for each constituent CSI-RS resources. In further another example, CSI report quantities are calculated expecting different combinations of power values from one or multiple power values configured for each constituent CSI-RS resources.

In 2340, the UE provides CSI reports for L CSI report sub-configurations in a PUCCH or PUSCH transmission to the serving gNB.

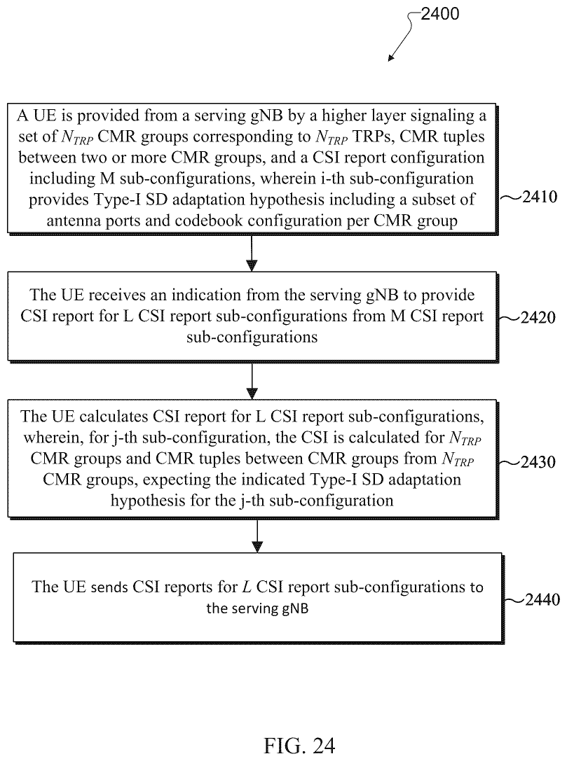

FIG. 24 illustrates a flowchart of an example UE procedure 2400 for reporting CSI for NC-JT from mTRPs with Type-1 SD adaptations according to embodiments of the present disclosure. For example, procedure 2400 for reporting CSI for NC-JT from mTRPs with Type-1 SD adaptations may be performed by any of the UEs 111-116 of FIG. 1, such as the UE 114. This example is for illustration only and other embodiments can be used without departing from the scope of the present disclosure.

The procedure begins in 2410, a UE is provided from a serving gNB by a higher layer signaling a set of N_{TRP} CMR groups corresponding to N_{TRP} TRPs, CMR tuples between two or more CMR groups, and a CSI report configuration including M sub-configurations, wherein i-th sub-configuration provides Type-I SD adaptation hypothesis including a subset of antenna ports and codebook configuration per CMR group. In 2420, the UE receives an indication from the serving gNB to provide CSI report for L CSI report sub-configurations from M CSI report sub-configurations. In 2430, the UE calculates CSI report for L CSI report sub-configurations, wherein, for j-th sub-configuration, the CSI is calculated for N_{TRP} CMR groups and CMR tuples between CMR groups from N_{TRP} CMR groups, expecting the indicated Type-I SD adaptation hypothesis for the j-th sub-configuration. In 2440, the UE sends CSI reports for L CSI report sub-configurations to the serving gNB.

A UE can be indicated a number of hypotheses on Type-1 SD adaptations of TRPs on a cell, and the UE can provide a number of CSI reports according to the indicated hypotheses. A CSI report configuration provided to the UE can include a number of sub-configurations associated with operation states on the cell which correspond to different hypotheses of active set of antenna ports transmitted from mTRPs of the cell, which can be further associated with transmission or reception parameters in one or more of a power, spatial, time, or frequency domain, including TRP on/off, on the cell.

In 2410, a UE is provided from a serving gNB by a higher layer signaling a set of N_{TRP} CMR groups corresponding to N_{TRP} TRPs, CMR tuples between two or more CMR groups, and a CSI report configuration including M sub-configurations, wherein i-th sub-configuration provides Type-1 SD adaptation hypothesis including a subset of antenna ports and codebook configuration per CMR group. For example, the higher layer signaling can be an RRC IE. The CSI-RS resource sets and the CSI report configuration including M sub-configurations may also be updated by a MAC CE that indicates corresponding subsets of the ones provided in the RRC IE.

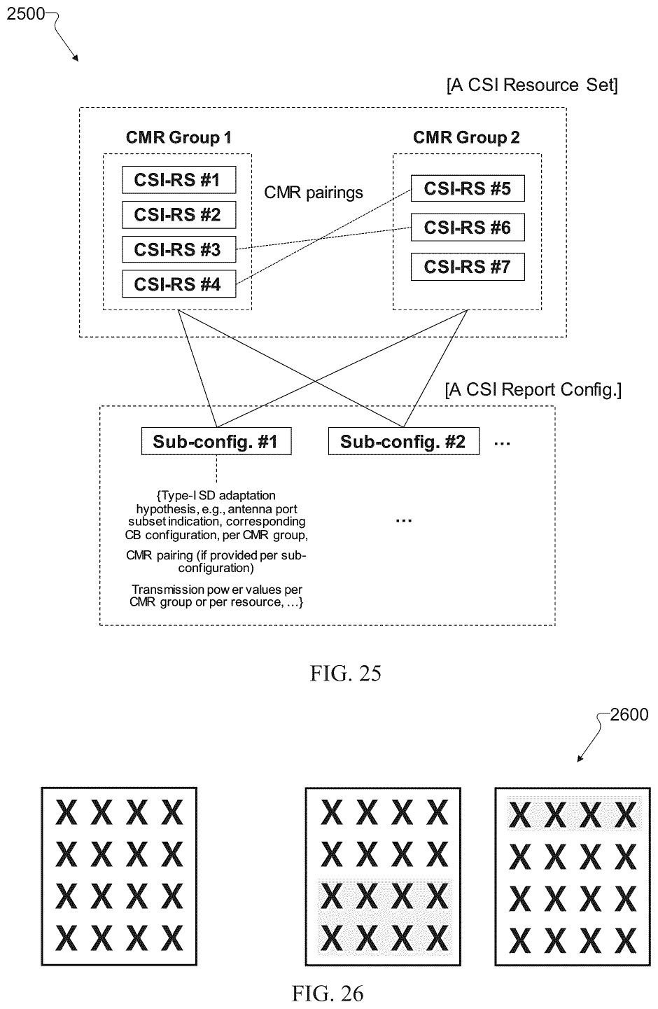

FIG. 25 illustrates a diagram of example associations 2500 for CSI-RS resources with CSI report sub-configurations according to embodiments of the present disclosure. For example, associations 2500 for CSI-RS resources with CSI report sub-configurations may be referenced by any of the UEs 111-116, such as the UE 113. This example is for illustration only and other embodiments can be used without departing from the scope of the present disclosure.

A CMR group in a CSI-RS resource set can be associated with more than one CSI report sub-configurations on a cell. If no TRP on/off adaptation is performed with Type-1 SD adaptation on the cell, CMR groups can be associated with each and every CSI report sub-configuration. If TRP on/off adaptation is performed with Type-1 SD adaptation on the cell, a number of CMR groups associated with a CSI report sub-configuration can be less than N_{TRP}.

FIG. 26 illustrates a diagram of example Type-1 SD adaptation configurations 2600 of CSI-RS antenna ports from a TRP according to embodiments of the present disclosure. For example, Type-1 SD adaptation configurations 2600 of CSI-RS antenna ports from a TRP can be implemented by BS 102 and/or BS 103 of FIG. 1. This example is for illustration only and other embodiments can be used without departing from the scope of the present disclosure.

For example, a UE is provided a CMR group including CSI-RS resources having 32 antenna ports in its default configuration.

According to Type-1 SD adaptation hypotheses of the TRP, with reference to FIG. 26, the UE can be indicated different antenna port subsets in CSI report sub-configurations as shown. Each CSI report sub-configuration can provide antenna port subset indication, which can be indicated per CMR group. For a CMR group having nrofPorts, the antenna port subset can be indicated using a bitmap of size nrofPorts along with corresponding codebook configurations such as N₁-N₂, codebook subset restriction, or rank restriction. An antenna port subset can be also indicated by providing a list of code division multiplexing (CDM) group indexes and, additionally, using a bitmap, whose size is equal to CDM group size, providing a list of active antenna ports within a CDM group. An antenna port subset can be also indicated by providing row-column indexes from the default codebook dimension N₁-N₂. In addition, the CMR pairings between two CMR groups as illustrated in FIG. 25, or CMR tuples in general for N_{TRP} TRPs, can be separately provided per CSI report sub-configuration. A CSI report sub-configuration can provide separate rank restrictions for single TRP transmission, i.e., using type1-SinglePanel-ri-RestrictionSTRP IE, and for joint transmission by multiple TRPs, i.e., using type1-SinglePanel-ri-RestrictionSDM IE. If TRP on/off adaptation or power domain adaptation is performed together with Type-1 SD adaptation on the cell, the CSI report sub-configuration can also provide indexes of active CMR groups or parameters related to transmission powers of signals or channels on the cell.

In 2420, the UE receives an indication from the serving gNB to provide CSI report for L CSI report sub-configurations from M CSI report sub-configurations. As described herein for 2320, triggering of CSI reporting can be via DCI in a PDCCH reception, or via MAC CE or RRC IE in a PDSCH reception. The signaling can be UE-specific, UE-group-specific, or cell-specific for example via a SIB.

In 2430, the UE calculates CSI report for L CSI report sub-configurations, wherein, for j-th sub-configuration, the CSI is calculated for N_{TRP} CMR groups and CMR tuples between CMR groups from N_{TRP} CMR groups, expecting the indicated Type-1 SD adaptation hypothesis for the j-th sub-configuration.

For a CSI report corresponding to a single TRP transmission, i.e., for a given CMR group, the UE may calculate and provide report quantities, such as RI, PMI, CQI, LI for a chosen CRI value from the CMR group, such as the CRI chosen for the first sub-configuration, according to the Type-1 SD adaptation hypothesis, e.g., antenna port subset and the corresponding codebook configurations, provided for the report sub-configuration in 2410. Alternatively, the UE may independently select a CRI for each of the report sub-configurations for the given CMR group based on the corresponding Type-1 SD adaptation hypothesis, and then calculate and provide other CSI report quantities accordingly. For a CSI report corresponding to a NC-JT by mTRPs, i.e., for a given CMR tuple, the UE may calculate and report a single CQI and multiple RI, PMI, and LI for a number of TRPs, i.e., CSI-RS resources, comprising the CMR tuple.

In 2440, the UE provides CSI reports for L CSI report sub-configurations in a PUCCH or PUSCH transmission to the serving gNB.

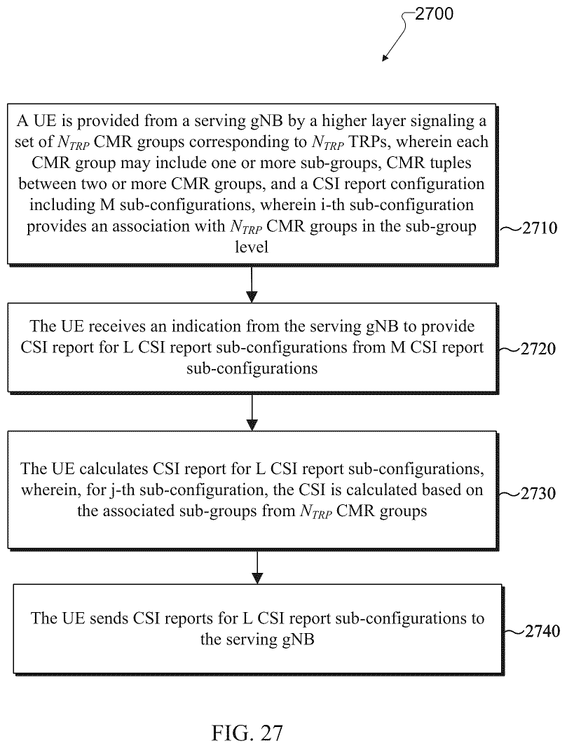

FIG. 27 illustrates a flowchart of an example UE procedure 2700 for reporting CSI for NC-JT from mTRPs with Type-2 SD adaptations according to embodiments of the present disclosure. For example, procedure 2700 for reporting CSI for NC-JT from mTRPs with Type-2 SD adaptations may be performed by any of the UEs 111-116 of FIG. 1, such as the UE 115. This example is for illustration only and other embodiments can be used without departing from the scope of the present disclosure.

The procedure begins in 2710, a UE is provided from a serving gNB by a higher layer signaling a set of N_{TRP} CMR groups corresponding to N_{TRP} TRPs, wherein each CMR group may include one or more sub-groups, CMR tuples between two or more CMR groups, and a CSI report configuration including M sub-configurations, wherein i-th sub-configuration provides an association with N_{TRP} CMR groups in the sub-group level. In 2720, the UE receives an indication from the serving gNB to provide CSI report for L CSI report sub-configurations from M CSI report sub-configurations. In 2730, the UE calculates CSI report for L CSI report sub-configurations, wherein, for j-th sub-configuration, the CSI is calculated based on the associated sub-groups from N_{TRP} CMR groups. In 2740, the UE sends CSI reports for L CSI report sub-configurations to the serving gNB.

A UE can be indicated a number of hypotheses on Type-2 SD adaptations of TRPs on a cell and the UE can provide a number of CSI reports according to the indicated hypotheses. A CSI report configuration provided to the UE can include a number of sub-configurations associated with network operation states (operation states for the cell) which correspond to different hypotheses of active antenna elements constituting antenna ports from TRPs on the cell, which can be further associated with transmission or reception parameters in one or more of a power, spatial, time, or frequency domain, including TRP on/off and Type-1 SD adaptation on the cell.

In 2710, a UE is provided from a serving gNB by a higher layer signaling a set of N_{TRP} CMR groups corresponding to N_{TRP} TRPs, wherein each CMR group may include one or more sub-groups, CMR tuples between two or more CMR groups, and a CSI report configuration including M sub-configurations, wherein i-th sub-configuration provides an association with N_{TRP} CMR groups in the sub-group level. For example, the higher layer signaling can be an RRC IE. The CSI-RS resource set, including multiple CMR groups and their pairings provided via CMR tuples, and the CSI report configuration including M sub-configurations may also be updated by a MAC CE or by DCI that indicates corresponding subsets of the ones provided in the RRC IE.

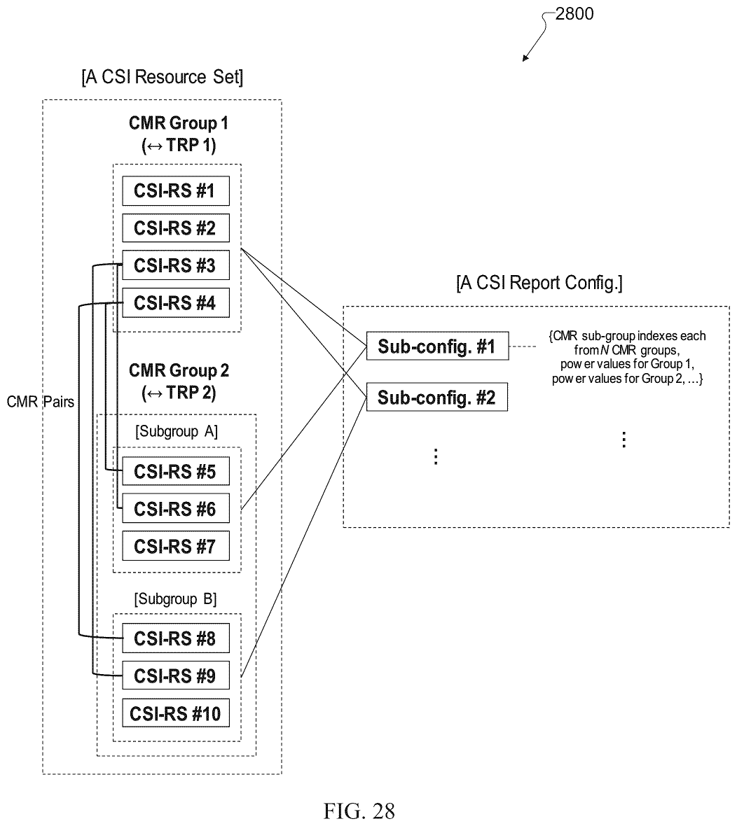

FIG. 28 illustrates a diagram of associations 2800 for CSI-RS resources with CSI report sub-configurations according to embodiments of the present disclosure. For example, associations 2800 for CSI-RS resources with CSI report sub-configurations may be referenced by any of the UEs 111-116, such as the UE 114. This example is for illustration only and other embodiments can be used without departing from the scope of the present disclosure.

A UE (e.g., the UE 116) is provided an association of N_{TRP} CMR groups with i-th CSI report sub-configuration on a cell, where the associated CMR groups correspond to a certain hypothesis of Type-2 SD adaptations of TRPs on the cell.

With reference to FIG. 28, an example association of CSI-RS resources with CSI report sub-configurations on a cell according to the disclosure is shown. In FIG. 28, TRP 2 is associated with two Type-2 SD adaptation hypotheses with two sets of CSI-RS resources, while TRP 1 may perform Type-1 SD adaptation, PD adaptation or no adaptation.

In one example, a CSI resource set may include a number of CMR groups, where the number of CMR groups may be larger than the number of TPRs, N_{TRP}, and the UE is provided a list of CMR group indexes from the set of CMR groups and the CMR tuples between the CMR groups in each CSI report sub-configuration. Therefore, in this case, one or more CMR groups may be associated with a certain TRP. In another example, a CSI resource set may include N_{TRP} CMR groups, wherein a CMR group may include one or more sub-groups, as exemplified in FIG. 28. The UE is then provided CMR sub-group indexes for CMR groups having more than one sub-groups and the CMR tuples involving CMR sub-groups in each CSI report sub-configuration. Only one sub-group in a CMR group can be associated with a given CSI report sub-configuration. A number of CSI-RS ports among the CSI-RS resources configured in a CMR sub-group shall be identical. The number of CSI-RS ports among CMR sub-groups of a CMR group may be different. In another example, a CSI resource set may include N_{TRP} CMR pools, wherein a CMR pool includes a number of CSI-RS resources and a subset of CSI-RS resources in a CMR pool may be associated with a CSI report sub-configuration. In the example of FIG. 28, {CSI-RS #5, CSI-RS #6, CSI-RS #7, CSI-RS #8, CSI-RS #9, and CSI-RS #10} may be configured as a CMR pool for TRP 2, and then the UE is provided a list of CSI-RS indexes, which may be an ordinal position within the pool, from the set of resources in the CMR pool and the CMR tuples between the CSI-RS resources of different CMR pools in each CSI report sub-configuration.

In 2720, the UE receives an indication from the serving gNB to provide CSI report for L CSI report sub-configurations from M CSI report sub-configurations. The methods provided for 2320 can be similarly applied to 2720.

In 2730, the UE calculates CSI report for L CSI report sub-configurations, wherein, for j-th sub-configuration, the CSI is calculated based on the associated sub-groups from N_{TRP} CMR groups. The methods provided for 2330 can be similarly applied to 2730.

In 2740, the UE provides CSI reports for L CSI report sub-configurations in a PUCCH or PUSCH transmission to the serving gNB.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE) to report channel state information (CSI), the method comprising:
receiving:
first information related to a CSI reference signal (CSI-RS) resource set including one or more non-zero power CSI-RSs (NZP CSI-RSs) on a cell,
second information related to a CSI report including a first number of CSI report sub-configurations, wherein:
a CSI report sub-configuration provides information related to a reception of one or more NZP CSI-RSs associated with a set of active transmission reception points (TRPs), and
a CSI report sub-configuration corresponds to a CSI sub-report for the set of active TRPs,
third information related to an uplink (UL) channel for transmitting the CSI report, and
the one or more NZP CSI-RSs based on the first information;
determining a second number of CSI sub-reports based on the second information, and the reception of the one or more NZP CSI-RSs associated with the set of active TRPs of the corresponding CSI report sub-configuration; and
transmitting the UL channel with the CSI report including the second number of CSI sub-reports based on the fourth information.

2. The method of claim 1, wherein:
the second information provides a list of NZP CSI-RSs from the CSI-RS resource set for a CSI report sub-configuration,
each NZP CSI-RS from the list of NZP CSI-RSs is associated with a corresponding active TRP,
determination of the corresponding CSI sub-report is based on a concatenated channel from the list of NZP CSI-RSs, and
a number of antenna ports in the concatenated channel is equal to a sum of a number of antenna ports of each NZP CSI-RS in the list of NZP CSI-RSs.

3. The method of claim 1, wherein the second information provides a list of NZP CSI-RSs from the CSI-RS resource set, an antenna port subset indication, and a CSI codebook configuration for a CSI report sub-configuration.

4. The method of claim 1, wherein:
the first information provides (i) a set of channel measurement resource (CMR) groups, wherein each CMR group in the set includes one or more NZP CSI-RSs from the CSI-RS resource set, and (ii) a set of NZP CSI-RS pairings from respective two or more CMR groups from the set of CMR groups,
the second information provides, for a CSI report sub-configuration, a subset of CMR groups from the set of CMR groups, wherein each CMR group in the subset is associated with a corresponding active TRP, and
determination of the corresponding CSI sub-report is based on one or more best channel selection from the CMR groups in the subset of CMR groups and a set of NZP CSI-RS pairings involving two or more NZP CSI-RSs associated with respective active TRPs.

5. The method of claim 1, wherein:
the first information provides a set of channel measurement resource (CMR) groups and a set of NZP CSI-RS pairings from respective two or more CMR groups from the set of CMR groups, and
the second information provides, for a CSI report sub-configuration, a subset of CMR groups from the set of CMR groups, an antenna port subset indication, and a CSI codebook configuration for a CSI report sub-configuration.

6. The method of claim 1, wherein:
the first information provides:
a set of channel measurement resource (CMR) groups,
one or more CMR sub-groups for each CMR group in the set of CMR groups, and
a set of NZP CSI-RS pairings from two or more CMR sub-groups, wherein the two or more CMR sub-groups belong to respective CMR groups, and
the second information provides, for a CSI report sub-configuration, a subset of CMR groups from the set of CMR groups and a CMR sub-group index for a corresponding CMR group in the subset of CMR groups.

7. The method of claim 1, wherein:
the second information provides, for a CSI report sub-configuration, parameters related to physical downlink shared channel (PDSCH) resource element (RE) to NZP CSI-RS RE power offset, and
the parameter is commonly provided and applied to the set of active TRPs or separately provided and applied to respective TRPs in the set of active TRPs.

8. A user equipment (UE), comprising:
a transceiver configured to receive:
first information related to a channel state information-reference signal (CSI-RS) resource set including one or more non-zero power CSI-RSs (NZP CSI-RSs) on a cell,
second information related to a CSI report including a first number of CSI report sub-configurations, wherein:
a CSI report sub-configuration provides information related to a reception of one or more NZP CSI-RSs associated with a set of active transmission reception points (TRPs), and
a CSI report sub-configuration corresponds to a CSI sub-report for the set of active TRPs,
third information related to an uplink (UL) channel for transmitting the CSI report, and
the one or more NZP CSI-RSs based on the first information; and
a processor operably coupled to the transceiver, the processor configured to determine a second number of CSI sub-reports based on the second information, and the reception of the one or more NZP CSI-RSs associated with the set of active TRPs of the corresponding CSI report sub-configuration,
wherein the transceiver is further configured to transmit the UL channel with the CSI report including the second number of CSI sub-reports based on the fourth information.

9. The UE of claim 8, wherein:
the second information provides a list of NZP CSI-RSs from the CSI-RS resource set for a CSI report sub-configuration,
each NZP CSI-RS from the list of NZP CSI-RSs is associated with a corresponding active TRP,
determination of the corresponding CSI sub-report is based on a concatenated channel from the list of NZP CSI-RSs, and
a number of antenna ports in the concatenated channel is equal to a sum of a number of antenna ports of each NZP CSI-RS in the list of NZP CSI-RSs.

10. The UE of claim 8, wherein the second information provides a list of NZP CSI-RSs from the CSI-RS resource set, an antenna port subset indication, and a CSI codebook configuration for a CSI report sub-configuration.

11. The UE of claim 8, wherein:
the first information provides (i) a set of channel measurement resource (CMR) groups, wherein each CMR group in the set includes one or more NZP CSI-RSs from the CSI-RS resource set, and (ii) a set of NZP CSI-RS pairings from respective two or more CMR groups from the set of CMR groups,
the second information provides, for a CSI report sub-configuration, a subset of CMR groups from the set of CMR groups, wherein each CMR group in the subset is associated with a corresponding active TRP, and
determination of the corresponding CSI sub-report is based on one or more best channel selection from the CMR groups in the subset of CMR groups and a set of NZP CSI-RS pairings involving two or more NZP CSI-RSs associated with respective active TRPs.

12. The UE of claim 8, wherein:
the first information provides a set of channel measurement resource (CMR) groups and a set of NZP CSI-RS pairings from respective two or more CMR groups from the set of CMR groups, and
the second information provides, for a CSI report sub-configuration, a subset of CMR groups from the set of CMR groups, an antenna port subset indication, and a CSI codebook configuration for a CSI report sub-configuration.

13. The UE of claim 8, wherein:
the first information provides:
a set of channel measurement resource (CMR) groups,
one or more CMR sub-groups for each CMR group in the set of CMR groups, and
a set of NZP CSI-RS pairings from two or more CMR sub-groups, wherein the two or more CMR sub-groups belong to respective CMR groups, and
the second information provides, for a CSI report sub-configuration, a subset of CMR groups from the set of CMR groups and a CMR sub-group index for a corresponding CMR group in the subset of CMR groups.

14. The UE of claim 8, wherein:
the second information provides, for a CSI report sub-configuration, parameters related to physical downlink shared channel (PDSCH) resource element (RE) to NZP CSI-RS RE power offset, and
the parameter is commonly provided and applied to the set of active TRPs or separately provided and applied to respective TRPs in the set of active TRPs.

15. A base station (BS), comprising:
a transceiver configured to:
transmit:
first information related to a channel state information-reference signal (CSI-RS) resource set including one or more non-zero power CSI-RSs (NZP CSI-RSs) on a cell,
second information related to a CSI report including a first number of CSI report sub-configurations, wherein:
a CSI report sub-configuration provides information related to a transmission of one or more NZP CSI-RSs associated with a set of active transmission reception points (TRPs), and
a CSI report sub-configuration corresponds to a CSI sub-report for the set of active TRPs,
third information related to an uplink (UL) channel for the CSI report, and
the one or more NZP CSI-RSs, and
receive the UL channel with the CSI report including a second number of CSI sub-reports based on the fourth information, wherein the second number of CSI sub-reports is based on the second information, and the transmission of the one or more NZP CSI-RSs associated with the set of active TRPs of the corresponding CSI report sub-configuration.

16. The BS of claim 15, wherein:
the second information provides a list of NZP CSI-RSs from the CSI-RS resource set for a CSI report sub-configuration,
each NZP CSI-RS from the list of NZP CSI-RSs is associated with a corresponding active TRP,
determination of the corresponding CSI sub-report is based on a concatenated channel from the list of NZP CSI-RSs, and
a number of antenna ports in the concatenated channel is equal to a sum of a number of antenna ports of each NZP CSI-RS in the list of NZP CSI-RSs.

17. The BS of claim 15, wherein the second information provides a list of NZP CSI-RSs from the CSI-RS resource set, an antenna port subset indication, and a CSI codebook configuration for a CSI report sub-configuration.

18. The BS of claim 15, wherein:
the first information provides (i) a set of channel measurement resource (CMR) groups, wherein each CMR group in the set includes one or more NZP CSI-RSs from the CSI-RS resource set, and (ii) a set of NZP CSI-RS pairings from respective two or more CMR groups from the set of CMR groups,
the second information provides, for a CSI report sub-configuration, a subset of CMR groups from the set of CMR groups, wherein each CMR group in the subset is associated with a corresponding active TRP, and
determination of the corresponding CSI sub-report is based on one or more best channel selection from the CMR groups in the subset of CMR groups and a set of NZP CSI-RS pairings involving two or more NZP CSI-RSs associated with respective active TRPs.

19. The BS of claim 15, wherein:
the first information provides a set of channel measurement resource (CMR) groups and a set of NZP CSI-RS pairings from respective two or more CMR groups from the set of CMR groups, and
the second information provides, for a CSI report sub-configuration, a subset of CMR groups from the set of CMR groups, an antenna port subset indication, and a CSI codebook configuration for a CSI report sub-configuration.

20. The BS of claim 15, wherein:
the first information provides:
a set of channel measurement resource (CMR) groups,
one or more CMR sub-groups for each CMR group in the set of CMR groups, and
a set of NZP CSI-RS pairings from two or more CMR sub-groups, wherein the two or more CMR sub-groups belong to respective CMR groups, and
the second information provides, for a CSI report sub-configuration, a subset of CMR groups from the set of CMR groups and a CMR sub-group index for a corresponding CMR group in the subset of CMR groups.
